SEQUENCE LISTING (3 sequences)

SEQ ID NO: 1 - DNA, 23 bp, Zymoseptoria tritici
gatgatggcaaccgcattcttag

SEQ ID NO: 2 - DNA, 23 bp, Zymoseptoria tritici
actatgtcttgtccaactcaagg

SEQ ID NO: 3 - DNA, 20 bp, Zymoseptoria tritici
tggtcaaatgtctttatgag

(19) United States
(12) Patent Application Publication
(10) Pub. No.: US 2024/0023551 A1
(43) Pub. Date: Jan. 25, 2024

(54) USE OF DHODH INHIBITOR FOR CONTROLLING RESISTANT PHYTOPATHOGENIC FUNGI IN CROPS

(71) Applicant: BAYER AKTIENGESELLSCHAFT, Leverkusen (DE)

(72) Inventors: Ruth MEISSNER, Leverkusen (DE); Andreas MEHL, Meerbusch (DE); Andreas GÖRTZ, Dormagen (DE)

(21) Appl. No.: 18/258,013

(22) PCT Filed: Dec. 15, 2021
(86) PCT No.: PCT/EP2021/085942

§ 371 Date: Jun. 16, 2023

(30) Foreign Application Priority Data
Dec. 18, 2020 (EP) 20215516.4

(51) Int. Cl. A01N 43/42; A01P 3/00; A01N 43/54

(52) U.S. Cl. CPC A01N 43/42; A01P 3/00; A01N 43/54

(57) ABSTRACT

The present invention relates to the use of a dihydroorotate dehydrogenase (DHODH) inhibitor for controlling phytopathogenic fungi in crops, wherein the phytopathogenic fungi contain a mutation in the mitochondrial cytochrome b gene conferring resistance to quinone-outside inhibitors (QoI) and/or a mutation in the SDH-B, SDH-C and/or SDH-D genes conferring resistance to succinate dehydrogenase inhibitors (SDHI).

The present invention relates to the use of a dihydroorotate dehydrogenase (DHODH) inhibitor for controlling phytopathogenic fungi in crops, wherein the phytopathogenic fungi contain a mutation in the mitochondrial cytochrome b gene conferring resistance to quinone-outside inhibitors (QoI) and/or a mutation in the SDH-B, SDH-C and/or SDH-D genes conferring resistance to succinate dehydrogenase inhibitors (SDHI).

A new class of antifungal drugs for the treatment of invasive fungal diseases in humans was recently reported. These novel antifungals, the orotomides, act via inhibition of dihydroorotate dehydrogenase, an enzyme of de novo pyrimidine biosynthesis (J. D. Oliver et al., PNAS 113 (2019), 12809-12814). It is further already known that tetflupyrolimet, a novel herbicide, which exhibits a high level of activity against grasses, interferes with de novo pyrimidine biosynthesis via the inhibition of dihydroorotate dehydrogenase (N. Umetsu et al., J. Pestic. Sci. 45 (2020), 54-74).

Quinone-outside inhibitors (QoI) and succinate dehydrogenase inhibitors (SDHI) are among the most important and extensively used groups of agricultural fungicides (Umetsu et al., J. Pestic. Sci. 45 (2020), 54-74). The widespread use of SDHI and Qo inhibitors has however resulted in the emergence of mutant pathogens which are resistant to such fungicides. Resistance to SDHI and Qo inhibitors has been detected in several phytopathogenic fungi, for example in Septoria tritici and Botrytis cinerea (H. F. Avenot et al., Crop Protection 29 (2010), 643-651, J. S. Pasche et al., Crop Protection 27 (2008), 427-435, WO 2020/120204, WO2018/089237).

Thus, there is a strong need for active ingredients which can be used for controlling resistant phytopathogenic fungi in crops.

This object has been solved by the use of a dihydroorotate dehydrogenase (DHODH) inhibitor for controlling phytopathogenic fungi in crops, wherein the phytopathogenic fungi contain a mutation in the mitochondrial cytochrome b gene conferring resistance to quinone-outside inhibitors (QoI) and/or a mutation in the SDH-B, SDH-C and/or SDH-D genes conferring resistance to succinate dehydrogenase inhibitors (SDHI).

It has been found that some novel quinoline fungicides, such as ipflufenoquin, quinofumelin and the quinoxaline of formula (I) as depicted below, act via inhibition of dihydroorotate dehydrogenase and are useful in controlling phytopathogenic fungi that show resistance against quinone-outside inhibitors (QoIs) and/or resistance to succinate dehydrogenase inhibitors (SDHIs). Surprisingly, it has further been found that the growth of fungi resistant to respiration inhibitors like QoIs and/or SDHIs can be controlled with much lower concentrations of fungicides inhibiting the dihydroorotate dehydrogenase than fungal isolates susceptible to respiration inhibitors. It was observed that QoI and/or SDHI resistant fungi are hypersensitive to fungicides inhibiting the dihydroorotate dehydrogenase.

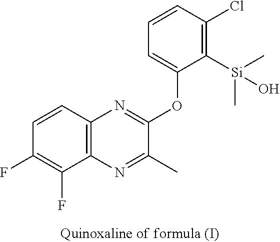 [SMILES: Cc1nc2c(F)c(F)ccc2nc1Oc1cccc(Cl)c1[Si](C)(C)O]

Ipflufenoquin (CAS No. 1314008-27-9), its fungicidal efficacy and active compounds combinations comprising ipflufenoquin are known from US 2012/289702, EP 2 762 002, EP 3 360 415, WO 2018/050421 and US2020/352168.

Quinofumelin (CAS No. 861647-84-9), its fungicidal efficacy and active compounds combinations comprising quinofumelin are known from EP 1 736 471 and EP 2 517 562,

The quinoxaline of formula (I) and its fungicidal activity are known from WO2017/072283.

Preferably, the DHODH inhibitor is selected from the group consisting of ipflufenoquin, quinofumelin, the quinoxaline of formula (I), (2R)-2-benzyl-N-(8-fluoro-2-methyl-3-quinolyl)-2,4-dimethyl-pentanamide, (2S)-2-benzyl-N-(8-fluoro-2-methyl-3-quinolyl)-2,4-dimethyl-pentanamide, 1-(4,5-dimethyl-1H-benzimidazol-1-yl)-4,4-difluoro-3,3-dimethyl-3,4-dihydroisoquinoline, 1-(4,5-dimethylbenzimidazol-1-yl)-4,4,5-trifluoro-3,3-dimethyl-isoquinoline, 1-(5-(fluoromethyl)-6-methyl-pyridin-3-yl)-4,4-difluoro-3,3-dimethyl-3,4-dihydroisoquinoline, 1-(5,6-dimethylpyridin-3-yl)-4,4-difluoro-3,3-dimethyl-3,4-dihydroisoquinoline, 1-(6-(difluoro-methyl)-5-methoxy-pyridin-3-yl)-4,4-difluoro-3,3-dimethyl-3,4-dihydroisoquinoline, 1-(6-(difluoromethyl)-5-methyl-pyridin-3-yl)-4,4-difluoro-3,3-dimethyl-3,4-dihydroisoquinoline, 1-(6,7-dimethylpyrazolo[1,5-a]pyridin-3-yl)-4,4,5-trifluoro-3,3-dimethyl-isoquinoline, 1-(6,7-dimethylpyrazolo[1,5-a]pyridin-3-yl)-4,4-difluoro-3,3-dimethyl-3,4-dihydroisoquinoline, 2-{2-fluoro-6-[(8-fluoro-2-methylquinolin-3-yl)oxy]phenyl}propan-2-ol, 3-(4,4,5-trifluoro-3,3-dimethyl-3,4-dihydroisoquinolin-1-yl)quinoline, 3-(4,4-difluoro-3,3-dimethyl-3,4-dihydroisoquinolin-1-yl)-8-fluoroquinoline, 3-(4,4-difluoro-5,5-dimethyl-4,5-dihydrothieno[2,3-c]pyridin-7-yl)quinoline, 3-(5-fluoro-3,3,4,4-tetramethyl-3,4-dihydroisoquinolin-1-yl)quinoline, 4,4-difluoro-3,3-dimethyl-1-(4-methylbenzimidazol-1-yl)isoquinoline, 4,4-difluoro-3,3-dimethyl-1-(6-methylpyrazolo[1,5-a]pyridin-3-yl)isoquinoline, 5-bromo-1-(5,6-dimethylpyridin-3-yl)-3,3-dimethyl-3,4-dihydroisoquinoline, 7,8-difluoro-N-[rac-1-benzyl-1,3-dimethyl-butyl]quinoline-3-carboxamide, 8-fluoro-3-(5-fluoro-3,3,4,4-tetramethyl-3,4-dihydroisoquinolin-1-yl)-quinoline, 8-fluoro-3-(5-fluoro-3,3-dimethyl-3,4-dihydroisoquinolin-1-yl)-quinoline, 8-fluoro-N-(4,4,4-trifluoro-2-methyl-1-phenylbutan-2-yl)quinoline-3-carboxamide, 8-fluoro-N-[(1R)-1-[(3-fluorophenyl)methyl]-1,3-dimethyl-butyl]quinoline-3-carboxamide, 8-fluoro-N-[(1S)-1-[(3-fluoro-phenyl)methyl]-1,3-dimethyl-butyl]quinoline-3-carboxamide, 8-fluoro-N-[(2S)-4,4,4-trifluoro-2-methyl-1-phenylbutan-2-yl]quinoline-3-carboxamide, 8-fluoro-N-[rac-1-[(3-fluorophenyl)methyl]-1,3-dimethyl-butyl]quinoline-3-carboxamide, 9-fluoro-2,2-dimethyl-5-(quinolin-3-yl)-2,3-dihydro-1,4-benzoxazepine, N-(2,4-dimethyl-1-phenylpentan-2-yl)-8-fluoroquinoline-3-carboxamide, N-[(1R)-1-benzyl-1,3-dimethyl-butyl]-7,8-difluoro-quinoline-3-carboxamide, N-[(1S)-1-benzyl-1,3-dimethyl-butyl]-7,8-difluoro-quinoline-3-carboxamide, N-[(2R)-2,4-dimethyl-1-phenylpentan-2-yl]-8-fluoroquinoline-3-carboxamide and rac-2-benzyl-N-(8-fluoro-2-methyl-3-quinolyl)-2,4-dimethyl-pentanamide.

More preferably, the DHODH inhibitor is selected from the group consisting of ipflufenoquin, quinofumelin, the quinoxaline of formula (I), 1-(4,5-dimethyl-1H-benzimidazol-1-yl)-4,4-difluoro-3,3-dimethyl-3,4-dihydroisoquinoline, 1-(6,7-dimethylpyrazolo[1,5-a]pyridin-3-yl)-4,4-difluoro-3,3-dimethyl-3,4-dihydroisoquinoline, 4,4-difluoro-3,3-dimethyl-1-(4-methylbenzimidazol-1-yl)isoquinoline, 4,4-difluoro-3,3-dimethyl-1-(6-methylpyrazolo pyridin-3-yl)isoquinoline, 7,8-difluoro-N-[rac-1-benzyl-1,3-dimethyl-butyl]quinoline-3-carboxamide, 8-fluoro-N-[(1R)-1-[(3-fluorophenyl)methyl]-1,3-dimethyl-butyl]quinoline-3-carboxamide, 8-fluoro-N-[(1S)-1-[(3-fluorophenyl)methyl]-1,3-dimethyl-butyl]quinoline-3-carboxamide, 8-fluoro-N-[(2S)-4,4,4-trifluoro-2-methyl-1-phenylbutan-2-yl]quinoline-3-carboxamide, 8-fluoro-N-[rac-1-[(3-fluorophenyl)methyl]-1,3-dimethyl-butyl]quinoline-3-carboxamide, N-[(1R)-1-benzyl-1,3-dimethyl-butyl]-7,8-difluoro-quinoline-3-carboxamide, N-[(1S)-1-benzyl-1,3-dimethyl-butyl]-7,8-difluoro-quinoline-3-carboxamide and N-[(2R)-2,4-dimethyl-1-phenylpentan-2-yl]-8-fluoroquinoline-3-carboxamide.

In some preferred embodiments, the DHODH inhibitor is selected from the group consisting of ipflufenoquin, quinofumelin and the quinoxaline of formula (I).

Most preferably, the DHODH inhibitor is ipflufenoquin.

Ipflufenoquin, quinofumelin and the quinoxaline of formula (I) may be used as such or in form of an agrochemically active salt thereof.

Agrochemically active salts include acid addition salts of inorganic and organic acids. Examples of inorganic acids are hydrohalic acids, such as hydrogen fluoride, hydrogen chloride, hydrogen bromide and hydrogen iodide, sulfuric acid, phosphoric acid and nitric acid, and acidic salts, such as sodium bisulfate and potassium bisulfate. Useful organic acids include, for example, formic acid, carbonic acid and alkanoic acids such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, saturated or mono- or diunsaturated fatty acids having 6 to 20 carbon atoms, alkylsulphuric monoesters, alkylsulphonic acids (sulphonic acids having straight-chain or branched alkyl radicals having 1 to 20 carbon atoms), arylsulphonic acids or aryldisulphonic acids (aromatic radicals, such as phenyl and naphthyl, which bear one or two sulphonic acid groups), alkylphosphonic acids (phosphonic acids having straight-chain or branched alkyl radicals having 1 to 20 carbon atoms), arylphosphonic acids or aryldiphosphonic acids (aromatic radicals, such as phenyl and naphthyl, which bear one or two phosphonic acid radicals), where the alkyl and aryl radicals may bear further substituents, for example p-toluenesulphonic acid, salicylic acid, p-aminosalicylic acid, 2-phenoxybenzoic acid, 2-acetoxybenzoic acid.

According to the invention, the DHODH inhibitor is used for controlling phytopathogenic fungi in crops, wherein the phytopathogenic fungi contain a mutation in the mitochondrial cytochrome b gene conferring resistance to quinone-outside inhibitors (QoI) and/or a mutation in the SDH-B, SDH-C and/or SDH-D genes conferring resistance to succinate dehydrogenase inhibitors (SDHI).

Preferably, the phytopathogenic fungi contain a mutation in the mitochondrial cytochrome b gene conferring resistance to quinone-outside inhibitors (QoI) selected from the group consisting of G143A and F129L and/or a mutation in the SDH-B, SDH-C and/or SDH-D genes conferring resistance to succinate dehydrogenase inhibitors (SDHI) selected from the group consisting of B-H272L, B-H272R, B-H272V, B-H272Y, B-H277Y, B-H278R, B-H278Y, B-N225F, B-N225H, B-N225L, B-N225T, B-N230A, B-N230I, B-N230K, B-N230T, C-F23S, C-G79R, C-H152R, C-H134R, C-H134Q, C-I29V, C-K49E, C-L85P, C-N75S, C-N86K, C-N86S, C-P80H, C-P80L, C-P84G, C-R64K, C-R151S, C-S19F, C-S135R, C-T33N, C-T34K, C-T34N, C-T79N, D-D123E, D-D124E, D-D124N, D-D129E, D-D145G, D-G138V, D-H133R and D-H134R.

In case of mutations in the mitochondrial cytochrome b gene conferring resistance to QoIs, the number refers to the position of the amino acid in the cytochrome b protein and the letters refer to the original and the mutated amino acid. For example, G143A refers to an amino acid substitution of glycine with alanine at position 143 of the cytochrome b protein.

In case of mutations in the SDH-B, SDH-C and/or SDH-D genes conferring resistance to SDHIs, the first letter refers to the gene coding for one of the four subunits A, B, C, D of the succinate dehydrogenase protein complex. SDH-A is a flavoprotein with a covalently bound flavin adenine dinucleotide; SDH-B is an iron-sulphur protein containing three iron-sulphur clusters [2Fe-2S], [4Fe-4S] and [3Fe-4S]; SDH-C and SDH-D are two hydrophobic membrane-spanning subunits that form the large and small subunits of cytochrome b forming the membrane anchor domain. The second part refers to the position of the amino acid in the respective protein and discloses the original and the mutated amino acid. For example, C-T79N refers to an amino acid substitution of threonine with asparagine at position 79 of the SDH-C protein.

More preferably, the phytopathogenic fungi contain a mutation in the mitochondrial cytochrome b gene conferring resistance to quinone-outside inhibitors (QoI) selected from the group consisting of G143A and F129L and/or a mutation in the SDH-B, SDH-C and/or SDH-D genes conferring resistance to succinate dehydrogenase inhibitors (SDHI) selected from the group consisting of B-H272R, B-H272Y, B-H277Y, B-H278R, B-H278Y, B-N225F, B-N225H, B-N225L, B-N225T, B-N230I, C-G79R, C-H152R, C-H134R, C-L85P, C-N86K, C-N86S, C-S135R, C-T79N, D-D123E and D-D129E.

Most preferably, the phytopathogenic fungi contain a mutation in the mitochondrial cytochrome b gene conferring resistance to quinone-outside inhibitors (QoI), wherein the mutation is G143A.

Control or controlling as used herein encompasses protective, curative and eradicative treatment of phytopathogenic fungi.

Phytopathogenic fungi which may be controlled in accordance with the invention include:

powdery mildew pathogens, for example Blumeria species, for example Blumeria graminis; Podosphaera species, for example Podosphaera leucotricha; Sphaerotheca species, for example Sphaerotheca fuliginea; Uncinula species, for example Erysiphe necator;
rust disease pathogens, for example Gymnosporangium species, for example Gymnosporangium sabinae; Hemileia species, for example Hemileia vastatrix; Phakopsora species, for example Phakopsora pachyrhizi, Phakopsora meibomiae or Phakopsora euvitis; Puccinia species, for example Puccinia recondita, Puccinia graminis oder Puccinia striiformis; Uromyces species, for example Uromyces appendiculatus;
leaf blotch pathogens and leaf wilt pathogens, for example, Alternaria species, for example Alternaria solani; Cercospora species, for example Cercospora beticola; Cladiosporium species, for example Cladiosporium cucumerinum; Cochliobolus species, for example Cochliobolus sativus (conidial form: Drechslera, syn: Helminthosporium) or Cochliobolus miyabeanus; Colletotrichum species, for example Colletotrichum lindemuthanium; Corynespora species, for example Corynespora cassiicola; Cycloconium species, for example Cycloconium oleaginum; Diaporthe species, for example Diaporthe citri; Elsinoe species, for example Elsinoe fawcettii; Gloeosporium species, for example Gloeosporium laeticolor; Glomerella species, for example Glomerella cingulata; Guignardia species, for example Guignardia bidwelli; Leptosphaeria species, for example Leptosphaeria maculans; Magnaporthe species, for example Magnaporthe grisea; Microdochium species, for example Microdochium nivale; Mycosphaerella species, for example Zymoseptoria tritici, Mycosphaerella arachidicola or Mycosphaerella fifiensis; Phaeosphaeria species, for example Phaeosphaeria nodorum; Pyrenophora species, for example Pyrenophora teres or Pyrenophora tritici repentis; Ramularia species, for example Ramularia collo-cygni or Ramularia areola; Rhynchosporium species, for example Rhynchosporium secalis; Septoria species, for example Septoria apii or Septoria lycopersici; Stagonospora species, for example Stagonospora nodorum; Typhula species, for example Typhula incarnata; Venturia species, for example Venturia inaequalis;
pathogens causing ear and/or panicle diseases (including corn cobs), for example, Alternaria species, for example Alternaria spp.; Aspergillus species, for example Aspergillus flavus; Cladosporium species, for example Cladosporium cladosporioides; Claviceps species, for example Claviceps purpurea; Fusarium species, for example Fusarium culmorum; Gibberella species, for example Gibberella zeae; Monographella species, for example Monographella nivalis; Stagnospora species, for example Stagnospora nodorum;
pathogens causing fruit rot, for example, Aspergillus species, for example Aspergillus flavus; Botrytis species, for example Botrytis cinerea; Monilinia species, for example Monilinia laxa; Penicillium species, for example Penicillium expansum or Penicillium purpurogenum; Rhizopus species, for example Rhizopus stolonifer; Sclerotinia species, for example Sclerotinia sclerotiorum; Verticilium species, for example Verticilium alboatrum;
pathogens causing seed- and soil-borne rot and wilt, and diseases of seedlings, for example, Alternaria species, for example Alternaria brassicicola; Aphanomyces species, for example Aphanomyces euteiches; Ascochyta species, for example Ascochyta lentis; Aspergillus species, for example Aspergillus flavus; Cladosporium species, for example Cladosporium herbarum; Cochliobolus species, for example Cochliobolus sativus (conidial form: Drechslera, Bipolaris Syn: Helminthosporium); Colletotrichum species, for example Colletotrichum coccodes; Fusarium species, for example Fusarium culmorum; Gibberella species, for example Gibberella zeae; Macrophomina species, for example Macrophomina phaseolina; Microdochium species, for example Microdochium nivale; Monographella species, for example Monographella nivalis; Penicillium species, for example Penicillium expansum; Phoma species, for example Phoma lingam; Phomopsis species, for example Phomopsis sojae; Phytophthora species, for example Phytophthora cactorum; Pyrenophora species, for example Pyrenophora graminea; Pyricularia species, for example Pyricularia oryzae; Pythium species, for example Pythium ultimum; Rhizoctonia species, for example Rhizoctonia solani; Rhizopus species, for example Rhizopus oryzae; Sclerotium species, for example Sclerotium rolfsii; Septoria species, for example Septoria nodorum; Typhula species, for example Typhula incarnata; Verticillium species, for example Verticillium dahliae;
pathogens causing diseases of plant tubers, for example, Rhizoctonia species, for example Rhizoctonia solani; Helminthosporium species, for example Helminthosporium solani;
pathogens causing diseases of soya beans on leaves, stems, pods and/or seeds, for example, Alternaria leaf spot (Alternaria spec. atrans tenuissima), Anthracnose (Colletotrichum gloeosporoides dematium var. truncatum), brown spot (Septoria glycines), Cercospora leaf spot and blight (Cercospora kikuchii), Choanephora leaf blight (Choanephora infundibulifera trispora (Syn.)), dactuliophora leaf spot (Dactuliophora glycines), downy mildew (Peronospora manshurica), Drechslera blight (Drechslera glycini), frogeye leaf spot (Cercospora sojina), leptosphaerulina leaf spot (Leptosphaerulina trifolii), Phyllostica leaf spot (Phyllosticta sojaecola), pod and stem blight (Phomopsis sojae), powdery mildew (Microsphaera diffusa), Pyrenochaeta leaf spot (Pyrenochaeta glycines), Rhizoctonia aerial, foliage, and web blight (Rhizoctonia solani), rust (Phakopsora pachyrhizi, Phakopsora meibomiae, Phakopsora euvitis), scab (Sphaceloma glycines), Stemphylium leaf blight (Stemphylium botryosum), sudden death syndrome (Fusarium virgulifomie), target spot (Corynespora cassiicola).

Preferably, the phytopathogenic fungi are selected from the group consisting of Monographella nivalis, Botrytis cinerea, Pyricularia oryzae, Septoria glycines, Cercospora kikuchii, Cercospora sojina, Rhizoctonia solani, Phakopsora pachyrhizi, Corynespora cassiicola, Blumeria graminis, Sphaerotheca fuliginea, Erysiphe necator, Alternaria solani, Cercospora beticola, Guignardia bidwellii, Magnaporthe grisea, Microdochium nivale, Zymoseptoria tritici, Mycosphaerella fijiensis, Phaeosphaeria nodorum, Pyrenophora teres, Pyrenophora tritici repentis, Ramularia collo-cygni, Ramularia areola, Rhynchosporium secalis, Venturia inaequalis, Monilinia laxa and Sclerotinia sclerotiorum.

More preferably, the phytopathogenic fungi are selected from the group consisting of Zymoseptoria tritici, Pyrenophora teres, Alternaria spp., Venturia inaequalis and Botrytis cinerea. Zymoseptoria tritici are particularly preferred.

Preferably, the DHODH inhibitor is used for control of the following phytopathogenic fungal strains, which contain a mutation in the mitochondrial cytochrome b gene conferring resistance to quinone-outside inhibitors (QoI):

Zymoseptoria tritici G143A, F129L;
Pyrenophora teres F129L;
Alternaria spp. G143A, F129L;
Botrytis cinerea G143A;
and/or for control of the following phytopathogenic fungal strains, which contain at least one mutation in the SDH-B, SDH-C and/or SDH-D genes conferring resistance to succinate dehydrogenase inhibitors (SDHI)):
Zymoseptoria tritici B-N225T, C-F23S, C-H152R, C-I29V, C-L85P, C-N86K, C-N86S, C-R151S, C-S19F, C-T33N, C-T34K, C-T34N, C-T79N, D-D129E;
Pyrenophora teres B-H277Y, C-G79R, C-H134R, C-K49E, C-N75S, C-R64K, C-S135R, D-D124E, D-D124N, D-D145G, D-G138V, D-H134R;
Alternaria spp. B-H278R, B-H278Y, C-H134R, C-H134Q, D-D123E, D-H133R.

The fungal strains as listed above which are resistant against QoIs or SDHIs are known from http://www.frac.info.

More preferably, the DHODH inhibitor is used for control of the following phytopathogenic fungal strains, which contain a mutation in the mitochondrial cytochrome b gene conferring resistance to quinone-outside inhibitors (QoI):

Zymoseptoria tritici G143A;
Pyrenophora teres F129L;
Alternaria spp. G143A, F129L;
Botrytis cinerea G143A;
and/or for control of the following phytopathogenic fungal strains, which contain at least one mutation in the SDH-B, SDH-C and/or SDH-D genes conferring resistance to succinate dehydrogenase inhibitors (SDHI)):
Zymoseptoria tritici B-N225T, C-H152R, C-L85P, C-N86K, C-N86S, C-T79N, D-D129E;
Pyrenophora teres B-H277Y, C-G79R, C-H134R, C-S135R;
Alternaria spp. B-H278R, B-H278Y, C-H134R, D-D123E.

In some embodiments, the phytopathogenic fungi which may be controlled in accordance with the invention are Zymoseptoria tritici, which contain a mutation in the mitochondrial cytochrome b gene conferring resistance to quinone-outside inhibitors (QoI) selected from G143A and F129L and/or a mutation in the SDH-B, SDH-C and/or SDH-D genes conferring resistance to succinate dehydrogenase inhibitors (SDHI) selected from the group consisting of B-N225T, C-F23S, C-H152R, C-I29V, C-L85P, C-N86K, C-N86S, C-R151S, C-S19F, C-T33N, C-T34K, C-T34N, C-T79N and D-D129E, more preferably a mutation in the mitochondrial cytochrome b gene conferring resistance to quinone-outside inhibitors (QoI) which is G143A and/or a mutation in the SDH-B, SDH-C and/or SDH-D genes conferring resistance to succinate dehydrogenase inhibitors (SDHI) selected from the group consisting of B-N225T, C-H152R, C-L85P, C-N86K, C-N86S, C-T79N and D-D129E.

In some other embodiments, the phytopathogenic fungi which may be controlled in accordance with the invention are Pyrenophora teres, which contain a mutation in the mitochondrial cytochrome b gene conferring resistance to quinone-outside inhibitors (QoI) which is F129L and/or a mutation in the SDH-B, SDH-C and/or SDH-D genes conferring resistance to succinate dehydrogenase inhibitors (SDHI) selected from the group consisting of B-H277Y, C-G79R, C-H134R, C-K49E, C-N75S, C-R64K, C-S135R, D-D124E, D-D124N, D-D145G, D-G138V and D-H134R, more preferably a mutation in the mitochondrial cytochrome b gene conferring resistance to quinone-outside inhibitors (QoI) which is F129L and/or a mutation in the SDH-B, SDH-C and/or SDH-D genes conferring resistance to succinate dehydrogenase inhibitors (SDHI) selected from the group consisting of B-H277Y, C-G79R, C-H134R and C-S135R.

In yet some other embodiments, the phytopathogenic fungi which may be controlled in accordance with the invention are Botrytis cinerea, which contain a mutation in the mitochondrial cytochrome b gene conferring resistance to quinone-outside inhibitors (QoI) which is G143A and/or a mutation in the SDH-B, SDH-C and/or SDH-D genes conferring resistance to succinate dehydrogenase inhibitors (SDHI) selected from the group consisting of B-H272L, B-H272R, B-H272V, B-H272Y, B-N225F, B-N225H, B-N225L, B-N230A, B-N230I, B-N230K, B-N230T, C-P80H, C-P80L and C-P84G.

In case of QoI-resistant strains, the number refers to the position of the amino acid in the cytochrome b protein and the letters refer to the original and the mutated amino acid. For example, G143A refers to an amino acid substitution of glycine with alanine at position 143 of the cytochrome b protein.

In case of SDHI-resistant strains, the first letter of the strain name refers to the gene coding for one of the four subunits A, B, C, D of the succinate dehydrogenase protein complex. SDH-A is a flavoprotein with a covalently bound flavin adenine dinucleotide; SDH-B is an iron-sulphur protein containing three iron-sulphur clusters [2Fe-2S], [4Fe-4S] and [3Fe-4S]; SDH-C and SDH-D are two hydrophobic membrane-spanning subunits that form the large and small subunits of cytochrome b forming the membrane anchor domain. The second part of the strain name refers to the position of the amino acid in the respective protein and discloses the original and the mutated amino acid. For example, C-T79N refers to an amino acid substitution of threonine with asparagine at position 79 of the SDH-C protein.

According to the invention, the DHODH inhibitor may be applied in combination with other active ingredients like fungicides, bactericides, acaricides, nematicides, insecticides, biological control agents or herbicides.

Suitable fungicides that may be used in combination with the DHODH inhibitor are selected from the group consisting of

1) Inhibitors of the ergosterol biosynthesis, for example (1.001) cyproconazole, (1.002) difenoconazole, (1.003) epoxiconazole, (1.004) fenbuconazole, (1.005) fenhexamid, (1.006) fenpropidin, (1.007) fenpropimorph, (1.008) fenpyrazamine, (1.009) Fluoxytioconazole, (1.010) fluquinconazole, (1.011) flutriafol, (1.012) hexaconazole, (1.013) imazalil, (1.014) imazalil sulfate, (1.015) ipconazole, (1.016) ipfentrifluconazole, (1.017) mefentrifluconazole, (1.018) metconazole, (1.019) myclobutanil, (1.020) paclobutrazol, (1.021) penconazole, (1.022) prochloraz, (1.023) propiconazole, (1.024) prothioconazole, (1.025) pyrisoxazole, (1.026) spiroxamine, (1.027) tebuconazole, (1.028) tetraconazole, (1.029) triadimenol, (1.030) tridemorph, (1.031) triticonazole, (1.032) (1R,2S,5 S)-5-(4-chlorobenzyl)-2-(chloromethyl)-2-methyl-1-(1H-1,2,4-triazol-1-ylmethyl)cyclopentanol, (1.033) (1S,2R,5R)-5-(4-chlorobenzyl)-2-(chloromethyl)-2-methyl-1-(1H-1,2,4-triazol-1-ylmethyl)cyclopentanol, (1.034) (2R)-2-(1-chlorocyclopropyl)-4-[(1R)-2,2-dichlorocyclopropyl]-1-(1H-1,2,4-triazol-1-yl)butan-2-ol, (1.035) (2R)-2-(1-chlorocyclopropyl)-4-[(1S)-2,2-dichlorocyclopropyl]-1-(1H-1,2,4-triazol-1-yl)butan-2-ol, (1.036) (2R)-2-[4-(4-chlorophenoxy)-2-(trifluoromethyl)phenyl]-1-(1H-1,2,4-triazol-1-yl)propan-2-ol, (1.037) (2S)-2-(1-chlorocyclopropyl)-4-[(1R)-2,2-dichlorocyclopropyl]-1-(1H-1,2,4-triazol-1-yl)butan-2-ol, (1.038) (2S)-2-(1-chlorocyclopropyl)-4-[(1S)-2,2-dichlorocyclopropyl]-1-(1H-1,2,4-triazol-1-yl)butan-2-ol, (1.039) (2S)-2-[4-(4-chlorophenoxy)-2-(trifluoromethyl)phenyl]-1-(1H-1,2,4-triazol-1-yl)propan-2-ol, (1.040) (R)-[3-(4-chloro-2-fluorophenyl)-5-(2,4-difluorophenyl)-1,2-oxazol-4-yl](pyridin-3-yl)methanol, (1.041) (S)-[3-(4-chloro-2-fluorophenyl)-5-(2,4-difluorophenyl)-1,2-oxazol-4-yl](pyridin-3-yl)methanol, (1.042) [3-(4-chloro-2-fluorophenyl)-5-(2,4-difluorophenyl)-1,2-oxazol-4-yl](pyridin-3-yl)methanol, (1.043) 1-({(2R,4S)-2-[2-chloro-4-(4-chlorophenoxy)phenyl]-4-methyl-1,3-dioxolan-2-yl}methyl)-1H-1,2,4-triazole, (1.044) 1-((2S,4S)-2-[2-chloro-4-(4-chlorophenoxy)phenyl]-4-methyl-1,3 triazole, (1.045) 1-{[3-(2-chlorophenyl)-2-(2,4-difluorophenyl)oxiran-2-yl]methyl}-1H-1,2,4-triazol-5-yl thiocyanate, (1.046) 1-{[rel(2R,3R)-3-(2-chlorophenyl)-2-(2,4-difluorophenyl)oxiran-2-yl]methyl}-1H-1,2,4-triazol-5-yl thiocyanate, (1.047) 1-{[rel(2R,3S)-3-(2-chlorophenyl)-2-(2,4-difluorophenyl)oxiran-2-yl]methyl}-1H-1,2,4-triazol-5-yl thiocyanate, (1.048) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.049) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.050) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.051) 2-[2R,4S,5S)-1-(2,4-dichlorophenyl)-5-hydroxy-2,6,6-trimethylheptan-4-yl]-2,4-dihydro-3H-1,2,4-triazole-3-thione, (1.052) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.053) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.054) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.055) 2-[(2S,4S,5 S)-1-(2,4-dichlorophenyl)-5-hydroxy-2,6,6-trimethylheptan-4-yl]-2,4-dihydro-3H-1,2,4-triazole-3-thione, (1.056) 2-[1-(2,4-dichlorophenyl)-(1.057) 2-[6-(4-bromophenoxy)-2-(trifluoromethyl)-3-pyridyl]-1-(1,2,4-triazol-1-yl)propan-2-ol, (1.058) 2-[6-(4-chlorophenoxy)-2-(trifluoromethyl)-3-pyridyl]-1-(1,2,4-triazol-1-yl)propan-2-ol, (1.059) 2-{[3-(2-chlorophenyl)-2-(2,4-difluorophenyl)oxiran-2-yl]methyl}-2,4-dihydro-3H-1,2,4-triazole-3-thione, (1.060) 2-{[rel(2R,3R)-3-(2-chlorophenyl)-2-(2,4-difluorophenyl)oxiran-2-yl]methyl}-2,4-dihydro-3H-1,2,4-triazole-3-thione, (1.061) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.062) 3-[2-(1-chlorocyclopropyl)-3-(3-chloro-2-fluoro-phenyl)-2-hydroxy-propyl]imidazole-4-carbonitrile, (1.063) 5-(4-chlorobenzyl)-2-(chloromethyl)-2-methyl-1-(1H-1,2,4-triazol-1-ylmethyl)cyclopentanol, (1.064) 5-(allylsulfanyl)-1-{[3-(2-chlorophenyl)-2-(2,4-difluorophenyl)oxiran-2-yl]methyl}-1H-1,2,4-triazole, (1.065) 5-(allylsulfanyl)-1-{[rel(2R,3R)-3-(2-chlorophenyl)-2-(2,4-difluorophenyl)oxiran-2-yl]methyl}-1H-1,2,4-triazole, (1.066) 5-(allylsulfanyl)-1-{[rel(2R,3S)-3-(2-chlorophenyl)-2-(2,4-difluorophenyl)oxiran-2-yl]methyl}-1H-1,2,4-triazole, (1.067) methyl 2-[2-chloro-4-(4-chlorophenoxy)phenyl]-2-hydroxy-3-(1H-1,2,4-triazol-1-yl)propanoate, (1.068) N′-(2,5-dimethyl-4-(2-methylbenzyl)phenyl)-N-ethyl-N-methylformimidamide, (1.069) N′-(2-chloro-4-(4-cyanobenzyl)-5-methylphenyl)-N-ethyl-N-methylformimidamide, (1.070) N′-(2-chloro-4-(4-methoxybenzyl)-5-methylphenyl)-N-ethyl-N-methylformimidamide, (1.071) N′-(2-chloro-5-methyl-4-phenoxyphenyl)-N-ethyl-N-methylimidoformamide, (1.072) N′-(4-benzyl-2-chloro-5-methylphenyl)-N-ethyl-N-methylformimidamide, (1.073) N′-[2-chloro-4-(2-fluorophenoxy)-5-methylphenyl]-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-2-methyl-6-[(1-propoxypropan-2-yl)oxy]pyridin-3-yl}-N-ethyl-N-methylimidoformamide, (1.077) N′-{5-bromo-6-[(1R)-1-(3,5-difluorophenyl)ethoxy]-2-methylpyridin-3-yl}-N-ethyl-N-methylimidoformamide, (1.078) N′-{5-bromo-6-[(1S)-1-(3,5-difluorophenyl)ethoxy]-2-methylpyridin-3-yl}-N-ethyl-N-methylimidoformamide, (1.079) N′-{5-bromo-6-[(cis-4-isopropylcyclohexyl)oxy]-2-methylpyridin-3-yl}-N-ethyl-N-methylimidoformamide, (1.080) N′-{5-bromo-6-[(trans-4-isopropylcyclohexyl)oxy]-2-methylpyridin-3-yl}-N-ethyl-N-methylimidoformamide, (1.081) N′-{5-bromo-6-[1-(3,5-difluorophenyl)ethoxy]-2-methylpyridin-3-yl}-N-ethyl-N-methylimidoformamide, (1.082) N-isopropyl-N′-[5-methoxy-2-methyl-4-(2,2,2-trifluoro-1-hydroxy-1-phenylethyl)phenyl]-N-methylimidoformamide, (1.083) p-tolylmethyl 4-[(E)-[ethyl(methyl)amino]methylene-amino]-2,5-dimethyl-benzoate;
2) Inhibitors of the respiratory chain at complex I or II, for example (2.001) benzovindiflupyr, (2.002) bixafen, (2.003) boscalid, (2.004) carboxin, (2.005) cyclobutrifluram, (2.006) flubeneteram, (2.007) fluindapyr, (2.008) fluopyram, (2.009) flutolanil, (2.010) fluxapyroxad, (2.011) furametpyr, (2.012) inpyrfluxam, (2.013) Isofetamid, (2.014) isoflucypram, (2.015) isopyrazam, (2.016) penflufen, (2.017) penthiopyrad, (2.018) pydiflumetofen, (2.019) pyrapropoyne, (2.020) pyraziflumid, (2.021) sedaxane, (2.022) Thifluzamide (aka trifluzamide), (2.023) 5,8-difluoro-N-[2-(2-fluoro-4-{[4-(trifluoromethyl)pyridin-2-yl]oxy}phenyl)ethyl]quinazolin-4-amine, (2.024) 5-chloro-N-[2-[1-(4-chlorophenyl)pyrazol-3-yl]oxyethyl]-6-ethyl-pyrimidin-4-amine, (2.025) N-[2-[1-(4-chlorophenyl)pyrazol-3-yl]oxyethyl]quinazolin-4-amine, (2.026) 1,3-dimethyl-N-(1,1,3-trimethyl-2,3-dihydro-1H-inden-4-yl)-1H-pyrazole-4-carboxamide, (2.027) 1,3-dimethyl-N-[(3R)-1,1,3-trimethyl-2,3-dihydro-1H-inden-4-yl]-1H-pyrazole-4-carboxamide, (2.028) 1,3-dimethyl-N-[(3S)-1,1,3-trimethyl-2,3-dihydro-1H-inden-4-yl]-1H-pyrazole-4-carboxamide, (2.029) 1-methyl-3-(trifluoromethyl)-N-[2′-(trifluoromethyl)biphenyl-2-yl]-1H-pyrazole-4-carboxamide, (2.030) 2-fluoro-6-(trifluoromethyl)-N-(1,1,3-trimethyl-2,3-dihydro-1H-inden-4-yl)benzamide, (2.031) 3-(difluoromethyl)-1-methyl-N-(1,1,3-trimethyl-2,3-dihydro-1H-inden-4-yl)-1H-pyrazole-4-carboxamide, (2.032) 3-(difluoromethyl)-1-methyl-N-[(3S)-1,1,3-trimethyl-2,3-dihydro-1H-inden-4-yl]-1H-pyrazole-4-carboxamide, (2.033) 3-(difluoromethyl)-N-[(3R)-7-fluoro-1,1,3-trimethyl-2,3-dihydro-1H-inden-4-yl]-1-methyl-1H-pyrazole-4-carboxamide, (2.034) 3-(difluoromethyl)-N-[(3S)-7-fluoro-1,1,3-trimethyl-2,3-dihydro-1H-inden-4-yl]-1-methyl-1H-pyrazole-4-carboxamide, (2.035) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.036) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.037) N-[1-(2,4-dichlorophenyl)-1-methoxypropan-2-yl]-3-(difluoromethyl)-1-methyl-1H-pyrazole-4-carboxamide, (2.038) N-[rac-(1S,2S)-2-(2,4-dichlorophenyl)cyclobutyl]-2-(trifluoromethyl)nicotinamide;
3) Inhibitors of the respiratory chain at complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) fenpicoxamid, (3.012) florylpicoxamid, (3.013) flufenoxystrobin, (3.014) fluoxastrobin, (3.015) kresoxim-methyl, (3.016) mandestrobin, (3.017) metarylpicoxamid, (3.018) metominostrobin, (3.019) metyltetraprole, (3.020) orysastrobin, (3.021) picoxystrobin, (3.022) pyraclostrobin, (3.023) pyrametostrobin, (3.024) pyraoxystrobin, (3.025) trifloxystrobin, (3.026) (2E)-2-{2-[({[(1E)-1-(3-{[(E)-1-fluoro-2-phenylvinyl]oxy}phenyl)ethylidene]-amino}oxy)methyl]phenyl}-2-(methoxyimino)-N-methylacetamide, (3.027) (2E,3Z)-5-{[1-(4-chloro-2-fluorophenyl)-1H-pyrazol-3-yl]oxy}-2-(methoxyimino)-N,3-dimethylpent-3-enamide, (3.028) (2E,3Z)-5-{[1-(4-chlorophenyl)-1H-pyrazol-3-yl]oxy}-2-(methoxyimino)-N,3-dimethylpent-3-enamide, (3.029) (2R)-2-{2-[(2,5-dimethylphenoxy)methyl]phenyl}-2-methoxy-N-methylacetamide, (3.030) (2S)-2-{2-[(2,5-dimethyl-phenoxy)methyl]phenyl}-2-methoxy-N-methylacetamide, (3.031) (Z,2E)-5-[1-(2,4-dichlorophenyl)pyrazol-3-yl]oxy-2-methoxyimino-N,3-dimethyl-pent-3-enamide, (3.032) methyl (Z)-2-(5-cyclohexyl-2-methyl-phenoxy)-3-methoxy-prop-2-enoate, (3.033) methyl (Z)-2-(5-cyclopentyl-2-methyl-phenoxy)-3-methoxy-prop-2-enoate, (3.034) methyl (Z)-3-methoxy-2-[2-methyl-5-(3-propylpyrazol-1-yl)phenoxy]prop-2-enoate, (3.035) methyl (Z)-3-methoxy-2-[2-methyl-5-[3-(trifluoromethyl)pyrazol-1-yl]phenoxy]prop-2-enoate, (3.036) methyl {5-[3-(2,4-dimethylphenyl)-1H-pyrazol-1-yl]-2-methylbenzyl}carbamate, (3.037) [rac-2-(4-bromo-7-fluoro-indol-1-yl)-1-methyl-propyl] (2S)-2-[(3-hydroxy-4-methoxy-pyridine-2-carbonyl)amino]propanoate, (3.038) [rac-2-(7-bromo-4-fluoro-indol-1-yl)-1-methyl-propyl] (2S)-2-[(3-acetoxy-4-methoxy-pyridine-2-carbonyl)amino]propanoate, (3.039) [rac-2-(7-bromoindol-1-yl)-1-methyl-propyl] (2S)-2-[(3-hydroxy-4-methoxy-pyridine-2-carbonyl)-amino]propanoate, (3.040) [rac-2-(3,5-dichloro-2-pyridyl)-1-methyl-propyl] (2S)-2-[(3-hydroxy-4-methoxy-pyridine-2-carbonyl)amino]propanoate, (3.041) [(1S)-1-[1-(1-naphthyl)cyclopropyl]ethyl] (2S)-2-[(3-acetoxy-4-methoxy-pyridine-2-carbonyl)amino]propanoate, (3.042) [(1S)-1-[1-(1-naphthyl)cyclopropyl]ethyl] (2S)-2-[(3-hydroxy-4-methoxy-pyridine-2-carbonyl)amino]propanoate, (3.043) [(1S)-1-[1-(1-naphthyl)cyclopropyl]ethyl](2S)-2-[[3-(acetoxymethoxy)-4-methoxy-pyridine-2-carbonyl]amino]propanoate, (3.044) [2-[[(1S)-2-[(1RS,2SR)-2-(3,5-dichloro-2-pyridyl)-1-methyl-propoxy]-1-methyl-2-oxo-ethyl]carbamoyl]-4-methoxy-3-pyridyl]oxymethyl 2-methylpropanoate, (3.045) N-(3-ethyl-3,5,5-trimethylcyclohexyl)-3-formamido-2-hydroxybenzamide;
4) Inhibitors of the mitosis and cell division, for example (4.001) carbendazim, (4.002) diethofencarb, (4.003) ethaboxam, (4.004) fluopicolide, (4.005) fluopimomide, (4.006) metrafenone, (4.007) pencycuron, (4.008) pyridachlometyl, (4.009) pyriofenone (chlazafenone), (4.010) thiabendazole, (4.011) thiophanate-methyl, (4.012) zoxamide, (4.013) 3-chloro-5-(4-chlorophenyl)-4-(2,6-difluorophenyl)-6-methylpyridazine, (4.014) 3-chloro-5-(6-chloropyridin-3-yl)-6-methyl-4-(2,4,6-trifluorophenyl)pyridazine, (4.015) 4-(2-bromo-4-fluorophenyl)-N-(2,6-difluorophenyl)-1,3-dimethyl-1H-pyrazol-5-amine, (4.016) 4-(2-bromo-4-fluorophenyl)-N-(2-bromo-6-fluorophenyl)-1,3-dimethyl-1H-pyrazol-5-amine, (4.017) 4-(2-bromo-4-fluorophenyl)-N-(2-bromophenyl)-1,3-dimethyl-1H-pyrazol-5-amine, (4.018) 4-(2-bromo-4-fluorophenyl)-N-(2-chloro-6-fluorophenyl)-1,3-dimethyl-1H-pyrazol-5-amine, (4.019) 4-(2-bromo-4-fluorophenyl)-N-(2-chlorophenyl)-1,3-dimethyl-1H-pyrazol-5-amine, (4.020) 4-(2-bromo-4-fluorophenyl)-N-(2-fluorophenyl)-1,3-dimethyl-1H-pyrazol-5-amine, (4.021) 4-(2-chloro-4-fluorophenyl)-N-(2,6-difluorophenyl)-1,3-dimethyl-1H-pyrazol-5-amine, (4.022) 4-(2-chloro-4-fluorophenyl)-N-(2-chloro-6-fluorophenyl)-1,3-dimethyl-1H-pyrazol-5-amine, (4.023) 4-(2-chloro-4-fluorophenyl)-N-(2-chlorophenyl)-1,3-dimethyl-1H-pyrazol-5-amine, (4.024) 4-(2-chloro-4-fluorophenyl)-N-(2-fluorophenyl)-1,3-dimethyl-1H-pyrazol-5-amine, (4.025) 4-(4-chlorophenyl)-5-(2,6-difluorophenyl)-3,6-dimethylpyridazine, (4.026) N-(2-bromo-6-fluorophenyl)-4-(2-chloro-4-fluorophenyl)-1,3-dimethyl-1H-pyrazol-5-amine, (4.027) N-(2-bromophenyl)-4-(2-chloro-4-fluorophenyl)-1,3-dimethyl-1H-pyrazol-5-amine, (4.028) N-(4-chloro-2,6-difluorophenyl)-4-(2-chloro-4-fluorophenyl)-1,3-dimethyl-1H-pyrazol-5-amine; 5) Compounds capable to have a multisite action, for example (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper (2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile;
6) Compounds capable to induce a host defence, for example (6.001) acibenzolar-S-methyl, (6.002) fosetyl-aluminium, (6.003) fosetyl-calcium, (6.004) fosetyl-sodium, (6.005) isotianil, (6.006) phosphorous acid and its salts, (6.007) probenazole, (6.008) tiadinil;
7) Inhibitors of the amino acid and/or protein biosynthesis, for example (7.001) cyprodinil, (7.002) kasugamycin, (7.003) kasugamycin hydrochloride hydrate, (7.004) oxytetracycline, (7.005) pyrimethanil;
8) Inhibitors of the ATP production, for example (8.001) silthiofam;
9) Inhibitors of the cell wall synthesis, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one;
10) Inhibitors of the lipid synthesis or transport, or membrane synthesis, for example (10.001) fluoxapiprolin, (10.002) natamycin, (10.003) oxathiapiprolin, (10.004) propamocarb, (10.005) propamocarb hydrochloride, (10.006) propamocarb-fosetylate, (10.007) tolclofos-methyl, (10.008) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (10.009) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (10.010) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (10.011) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (10.012) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone, (10.013) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (10.014) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (10.015) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (10.016) 3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (10.017) 9-fluoro-3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (10.018) 3-[2-(1-{[3,5-bis(difluoromethyl)-1H-pyrazol-1-yl]acetyl}piperidin-4-yl)-1,3-thiazol-4-yl]-1,5-dihydro-2,4-benzodioxepin-6-yl methanesulfonate, (10.019) 3-[2-(1-{[3,5-bis(difluoromethyl)-1H-pyrazol-1-yl]acetyl}piperidin-4-yl)-1,3-thiazol-4-yl]-9-fluoro-1,5-dihydro-2,4-benzodioxepin-6-yl methanesulfonate;
11) Inhibitors of the melanin biosynthesis, for example (11.001) tolprocarb, (11.002) tricyclazole;
12) Inhibitors of the nucleic acid synthesis, for example (12.001) benalaxyl, (12.002) benalaxyl-M (kiralaxyl), (12.003) metalaxyl, (12.004) metalaxyl-M (mefenoxam);
13) Inhibitors of the signal transduction, for example (13.001) fludioxonil, (13.002) iprodione, (13.003) procymidone, (13.004) proquinazid, (13.005) quinoxyfen, (13.006) vinclozolin;
14) Compounds capable to act as an uncoupler, for example (14.001) fluazinam, (14.002) meptyldinocap;
15) Further compounds, for example (15.001) abscisic acid, (15.002) aminopyrifen, (15.003) benthiazole, (15.004) bethoxazin, (15.005) capsimycin, (15.006) carvone, (15.007) chinomethionat, (15.008) chloroinconazide, (15.009) cufraneb, (15.010) cyflufenamid, (15.011) cymoxanil, (15.012) cyprosulfamide, (15.013) dipymetitrone, (15.014) D-tagatose, (15.015) flufenoxadiazam, (15.016) flumetylsulforim, (15.017) flutianil, (15.018) ipflufenoquin, (15.019) methyl isothiocyanate, (15.020) mildiomycin, (15.021) nickel dimethyldithiocarbamate, (15.022) nitrothal-isopropyl, (15.023) oxyfenthiin, (15.024) pentachlorophenol and salts, (15.025) picarbutrazox, (15.026) quinofumelin, (15.027) tebufloquin, (15.028) tecloftalam, (15.029) tolnifanide, (15.030) 2-(6-benzylpyridin-2-yl)quinazoline, (15.031) 2-[6-(3-fluoro-4-methoxyphenyl)-5-methylpyridin-2-yl]quinazoline, (15.032) 2-phenylphenol and salts, (15.033) 4-amino-5-fluoropyrimidin-2-ol (tautomeric form: 4-amino-5-fluoropyrimidin-2(1H)-one), (15.034) 4-oxo-4-[(2-phenylethyl)amino]butanoic acid, (15.035) 5-amino-1,3,4-thiadiazole-2-thiol, (15.036) 5-chloro-N′-phenyl-N′-(prop-2-yn-1-yl)thiophene-2-sulfonohydrazide, (15.037) 5-fluoro-2-[(4-fluorobenzyl)oxy]pyrimidin-4-amine, (15.038) 5-fluoro-2-[(4-methylbenzyl)oxy]pyrimidin-4-amine, (15.039) but-3-yn-1-yl {6-[({[(Z)-(1-methyl-1H-tetrazol-5-yl)(phenyl)methylene]amino}oxy)methyl]pyridin-2-yl}carbamate, (15.040) ethyl (2Z)-3-amino-2-cyano-3-phenylacrylate, (15.041) methyl 2-[acetyl-[2-ethylsulfonyl-4-(trifluoromethyl)benzoyl]amino]-5-(trifluoromethoxy)benzoate, (15.042) N-acetyl-N-[2-bromo-4-(trifluoromethoxy)phenyl]-2-ethylsulfonyl-4-(trifluoromethyl)benzamide, (15.043) phenazine-1-carboxylic acid, (15.044) propyl 3,4,5-trihydroxybenzoate, (15.045) quinolin-8-ol, (15.046) quinolin-8-ol sulfate (2:1), (15.047) (2R)-2-benzyl-N-(8-fluoro-2-methyl-3-quinolyl)-2,4-dimethyl-pentanamide, (15.048) (2S)-2-benzyl-N-(8-fluoro-2-methyl-3-quinolyl)-2,4-dimethyl-pentanamide, (15.049) 1-(4,5-dimethyl-1H-benzimidazol-1-yl)-4,4-difluoro-3,3-dimethyl-3,4-dihydroisoquinoline, (15.050) 1-(4,5-dimethylbenzimidazol-1-yl)-4,4,5-trifluoro-3,3-dimethyl-isoquinoline, (15.051) 1-(5-(fluoromethyl)-6-methyl-pyridin-3-yl)-4,4-difluoro-3,3-dimethyl-3,4-dihydroisoquinoline, (15.052) 1-(5,6-dimethylpyridin-3-yl)-4,4-difluoro-3,3-dimethyl-3,4-dihydroisoquinoline, (15.053) 1-(6-(difluoromethyl)-5-methoxy-pyridin-3-yl)-4,4-difluoro-3,3-dimethyl-3,4-dihydroisoquinoline, (15.054) 1-(6-(difluoromethyl)-5-methyl-pyridin-3-yl)-4,4-difluoro-3,3-dimethyl-3,4-dihydroisoquinoline, (15.055) 1-(6,7-dimethylpyrazolo[1,5-a]pyridin-3-yl)-4,4,5-trifluoro-3,3-dimethyl-isoquinoline, (15.056) 1-(6,7-dimethylpyrazolo[1,5-a]pyridin-3-yl)-4,4-difluoro-3,3-dimethyl-3,4-dihydroisoquinoline, (15.057) 2-{2-fluoro-6-[(8-fluoro-2-methylquinolin-3-yl)oxy]phenyl}propan-2-ol, (15.058) 3-(4,4,5-trifluoro-3,3-dimethyl-3,4-dihydroisoquinolin-1-yl)quinoline, (15.059) 3-(4,4-difluoro-3,3-dimethyl-3,4-dihydroisoquinolin-1-yl)-8-fluoroquinoline, (15.060) 3-(4,4-difluoro-5,5-dimethyl-4,5-dihydrothieno[2,3-c]pyridin-7-yl)quinoline, (15.061) 3-(5-fluoro-3,3,4,4-tetramethyl-3,4-dihydroisoquinolin-1-yl)quinoline, (15.062) 4,4-difluoro-3,3-dimethyl-1-(4-methylbenzimidazol-1-yl)isoquinoline, (15.063) 4,4-difluoro-3,3-dimethyl-1-(6-methylpyrazolo[1,5-a]pyridin-3-yl)isoquinoline, (15.064) 5-bromo-1-(5,6-dimethylpyridin-3-yl)-3,3-dimethyl-3,4-dihydroisoquinoline, (15.065) 7,8-difluoro-N-[rac-1-benzyl-1,3-dimethyl-butyl]quinoline-3-carboxamide, (15.066) 8-fluoro-3-(5-fluoro-3,3,4,4-tetramethyl-3,4-dihydroisoquinolin-1-yl)-quinoline, (15.067) 8-fluoro-3-(5-fluoro-3,3-dimethyl-3,4-dihydroisoquinolin-1-yl)-quinoline, (15.068) 8-fluoro-N-(4,4,4-trifluoro-2-methyl-1-phenylbutan-2-yl)quinoline-3-carboxamide, (15.069) 8-fluoro-N-[(1R)-1-[(3-fluorophenyl)methyl]-1,3-dimethyl-butyl]-quinoline-3-carboxamide, (15.070) 8-fluoro-N-[(1S)-1-[(3-fluorophenyl)methyl]-1,3-dimethyl-butyl]quinoline-3-carboxamide, (15.071) 8-fluoro-N-[(2S)-4,4,4-trifluoro-2-methyl-1-phenylbutan-2-yl]quinoline-3-carboxamide, (15.072) 8-fluoro-N-[rac-1-[(3-fluorophenyl)methyl]-1,3-dimethyl-butyl]quinoline-3-carboxamide, (15.073) 9-fluoro-2,2-dimethyl-5-(quinolin-3-yl)-2,3-dihydro-1,4-benzoxazepine, (15.074) N-(2,4-dimethyl-1-phenylpentan-2-yl)-8-fluoroquinoline-3-carboxamide, (15.075) N-[(1R)-1-benzyl-1,3-dimethyl-butyl]-7,8-difluoro-quinoline-3-carboxamide, (15.076) N-[(1S)-1-benzyl-1,3-dimethyl-butyl]-7,8-difluoro-quinoline-3-carboxamide, (15.077) N-[(2R)-2,4-dimethyl-1-phenylpentan-2-yl]-8-fluoroquinoline-3-carboxamide, (15.078) rac-2-benzyl-N-(8-fluoro-2-methyl-3-quinolyl)-2,4-dimethyl-pentanamide, (15.079) 1,1-diethyl-3-[[4-[5-(trifluoromethyl)-1,2,4-oxadiazol-3-yl]phenyl]methyl]urea, (15.080) 1,3-dimethoxy-1-[[4-[5-(trifluoromethyl)-1,2,4-oxadiazol-3-yl]phenyl]methyl]urea, (15.081) 1-[[3-fluoro-4-(5-(trifluoromethyl)-1,2,4-oxadiazol-3-yl)phenyl]methyl]azepan-2-one, (15.082) 1-[[4-[5-(trifluoromethyl)-1,2,4-oxadiazol-3-yl]phenyl]methyl]piperidin-2-one, (15.083) 1-methoxy-1-methyl-3-[[4-[5-(trifluoromethyl)-1,2,4-oxadiazol-3-yl]phenyl]methyl]urea, (15.084) 1-methoxy-3-methyl-1-[[4-[5-(trifluoromethyl)-1,2,4-oxadiazol-3-yl]phenyl]-methyl]urea, (15.085) 1-methoxy-3-methyl-1-[[4-[5-(trifluoromethyl)-1,2,4-oxadiazol-3-yl]phenyl]methyl]urea, (15.086) 2-(difluoromethyl)-5-[2-[1-(2,6-difluorophenyl)cyclopropoxy]pyrimidin-5-yl]-1,3,4-oxadiazole, (15.087) 2,2-difluoro-N-methyl-2-[4-[5-(trifluoromethyl)-1,2,4-oxadiazol-3-yl]phenyl]acetamide, (15.088) 3,3-dimethyl-1-[[4-[5-(trifluoromethyl)-1,2,4-oxadiazol-3-yl]phenyl]methyl]piperidin-2-one, (15.089) 3-ethyl-1-methoxy-1-[[4-[5-(trifluoromethyl)-1,2,4-oxadiazol-3-yl]phenyl]methyl]urea, (15.090) 4,4-dimethyl-1-[[4-[5-(trifluoromethyl)-1,2,4-oxadiazol-3-yl]phenyl]methyl]pyrrolidin-2-one, (15.091) 4,4-dimethyl-2-[[4-[5-(trifluoromethyl)-1,2,4-oxadiazol-3-yl]phenyl]methyl]isoxazolidin-3-one, (15.092) 4-[5-(trifluoromethyl)-1,2,4-oxadiazol-3-yl]phenyl dimethylcarbamate, (15.093) 5,5-dimethyl-2-[[4-[5-(trifluoromethyl)-1,2,4-oxadiazol-3-yl]phenyl]methyl]isoxazolidin-3-one, (15.094) 5-[5-(difluoromethyl)-1,3,4-oxadiazol-2-yl]-N-[(1R)-1-(2,6-difluorophenyl)ethyl]pyrimidin-2-amine, (15.095) 5-[5-(difluoromethyl)-1,3,4-oxadiazol-2-yl]-N-[(1R)-1-(2,6-difluorophenyl)propyl]pyrimidin-2-amine, (15.096) 5-[5-(difluoromethyl)-1,3,4-oxadiazol-2-yl]-N-[(1R)-1-(2-fluorophenyl)ethyl]pyrimidin-2-amine, (15.097) 5-[5-(difluoromethyl)-1,3,4-oxadiazol-2-yl]-N-[(1R)-1-(2-fluorophenyl)ethyl]pyrimidin-2-amine, (15.098) 5-[5-(difluoromethyl)-1,3,4-oxadiazol-2-yl]-N-[(1R)-1-(3,5-difluorophenyl)ethyl]pyrimidin-2-amine, (15.099) 5-[5-(difluoromethyl)-1,3,4-oxadiazol-2-yl]-N-[(1R)-1-phenylethyl]pyrimidin-2-amine, (15.100) 5-[5-(difluoromethyl)-1,3,4-oxadiazol-2-yl]-N-[1-(2-fluorophenyl)cyclopropyl]pyrimidin-2-amine, (15.101) 5-methyl-1-[[4-[5-(trifluoromethyl)-1,2,4-oxadiazol-3-yl]phenyl]methyl]pyrrolidin-2-one, (15.102) ethyl 1-{4-[5-(trifluoromethyl)-1,2,4-oxadiazol-3-yl]benzyl}-1H-pyrazole-4-carboxylate, (15.103) methyl {4-[5-(trifluoromethyl)-1,2,4-oxadiazol-3-yl]phenyl}carbamate, (15.104) N-(1-methylcyclopropyl)-4-[5-(trifluoromethyl)-1,2,4-oxadiazol-3-yl]benzamide, (15.105) N-(2,4-difluorophenyl)-4-[5-(trifluoromethyl)-1,2,4-oxadiazol-3-yl]benzamide, (15.106) N,2-dimethoxy-N-[[4-[5-(trifluoromethyl)-1,2,4-oxadiazol-3-yl]phenyl]methyl]propanamide, (15.107) N,N-dimethyl-1-{4-[5-(trifluoromethyl)-1,2,4-oxadiazol-3-yl]benzyl}-1H-1,2,4-triazol-3-amine, (15.108) N-[(E)-methoxyiminomethyl]-4-[5-(trifluoromethyl)-1,2,4-oxadiazol-3-yl]benzamide, (15.109) N-[(E)-N-methoxy-C-methyl-carbonimidoyl]-4-[5-(trifluoromethyl)-1,2,4-oxadiazol-3-yl]benzamide, (15.110) N-[(Z)-methoxyiminomethyl]-4-[5-(trifluoromethyl)-1,2,4-oxadiazol-3-yl]benzamide, (15.111) N-[(Z)-N-methoxy-C-methyl-carbonimidoyl]-4-[5-(trifluoromethyl)-1,2,4-oxadiazol-3-yl]benzamide, (15.112) N-[[2,3-difluoro-4-[5-(trifluoromethyl)-1,2,4-oxadiazol-3-yl]phenyl]methyl]-3,3,3-trifluoro-propanamide, (15.113) N-[[4-[5-(trifluoromethyl)-1,2,4-oxadiazol-3-yl]phenyl]methyl]propanamide, (15.114) N-[4-[5-(trifluoromethyl)-1,2,4-oxadiazol-3-yl]phenyl]-cyclopropanecarboxamide, (15.115) N-{2,3-difluoro-4-[5-(trifluoromethyl)-1,2,4-oxadiazol-3-yl]benzyl}-butanamide, (15.116) N-{4-[5-(trifluoromethyl)-1,2,4-oxadiazol-3-yl]benzyl}cyclopropanecarboxamide, (15.117) N-{4-[5-(trifluoromethyl)-1,2,4-oxadiazol-3-yl]phenyl}propanamide, (15.118) N-allyl-N-[[4-[5-(trifluoromethyl)-1,2,4-oxadiazol-3-yl]phenyl]methyl]acetamide, (15.119) N-allyl-N-[[4-[5-(trifluoromethyl)-1,2,4-oxadiazol-3-yl]phenyl]methyl]propanamide, (15.120) N-ethyl-2-methyl-N-[[4-[5-(trifluoromethyl)-1,2,4-oxadiazol-3-yl]phenyl]methyl]propanamide, (15.121) N-methoxy-N-[[4-[5-(trifluoromethyl)-1,2,4-oxadiazol-3-yl]phenyl]methyl]cyclopropanecarboxamide, (15.122) N-methyl-4-[5-(trifluoromethyl)-1,2,4-oxadiazol-3-yl]benzamide, (15.123) N-methyl-4-[5-(trifluoromethyl)-1,2,4-oxadiazol-3-yl]benzenecarbothioamide, and (15.124) N-methyl-N-phenyl-4-[5-(trifluoromethyl)-1,2,4-oxadiazol-3-yl]benzamide.

The DHODH inhibitor can more advantageously be used in combination with at least one further fungicide selected from

inhibitors of the respiratory chain at complex I or II selected from the group consisting of benzovindiflupyr, bixafen, boscalid, carboxin, cyclobutrifluram, flubeneteram, fluindapyr, fluopyram, flutolanil, fluxapyroxad, furametpyr, inpyrfluxam, isofetamid, isoflucypram, isopyrazam, penflufen, penthiopyrad, pydiflumetofen, pyrapropoyne, pyraziflumid, sedaxane, 1,3-dimethyl-N-(1,1,3-trimethyl-2,3-dihydro-1H-inden-4-yl)-1H-pyrazole-4-carboxamide, 1,3-dimethyl-N-[(3R)-1,1,3-trimethyl-2,3-dihydro-1H-inden-4-yl]-1H-pyrazole-4-carboxamide, 1,3-dimethyl-N-[(3S)-1,1,3-trimethyl-2,3-dihydro-1H-inden-4-yl]-1H-pyrazole-4-carboxamide, 1-methyl-3-(trifluoromethyl)-N-[2′-(trifluoromethyl)biphenyl-2-yl]-1H-pyrazole-4-carboxamide, 2-fluoro-6-(trifluoromethyl)-N-(1,1,3-trimethyl-2,3-dihydro-1H-inden-4-yl)benzamide, 3-(difluoromethyl)-1-methyl-N-(1,1,3-trimethyl-2,3-dihydro-1H-inden-4-yl)-1H-pyrazole-4-carboxamide, 3-(difluoromethyl)-1-methyl-N-[(3S)-1,1,3-trimethyl-2,3-dihydro-1H-inden-4-yl]-1H-pyrazole-4-carboxamide, 3-(difluoromethyl)-N-[(3R)-7-fluoro-1,1,3-trimethyl-2,3-dihydro-1H-inden-4-yl]-1-methyl-1H-pyrazole-4-carboxamide, 3-(difluoromethyl)-N-[(3S)-7-fluoro-1,1,3-trimethyl-2,3-dihydro-1H-inden-4-yl]-1-methyl-1H-pyrazole-4-carboxamide, 5,8-difluoro-N-[2-(2-fluoro-4-{[4-(trifluoromethyl)pyridin-2-yl]oxy}phenyl)ethyl]quinazolin-4-amine, N-[(1R,4S)-9-(dichloro-methylene)-1,2,3,4-tetrahydro-1,4-methanonaphthalen-5-yl]-3-(difluoromethyl)-1-methyl-1H-pyrazole-4-carboxamide, N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, N-[1-(2,4-dichlorophenyl)-1-methoxypropan-2-yl]-3-(difluoromethyl)-1-methyl-1H-pyrazole-4-carboxamide and N-[rac-(1S,2S)-2-(2,4-dichlorophenyl)cyclobutyl]-2-(trifluoromethyl)-nicotinamide; and
inhibitors of the respiratory chain at complex III selected from the group consisting of ametoctradin, amisulbrom, azoxystrobin, coumethoxystrobin, coumoxystrobin, cyazofamid, dimoxystrobin, enoxastrobin, famoxadone, fenamidone, fenpicoxamid, florylpicoxamid, flufenoxystrobin, fluoxastrobin, kresoxim-methyl, mandestrobin, metarylpicoxamid, metominostrobin, metyltetraprol, orysastrobin, picoxystrobin, pyraclostrobin, pyrametostrobin, pyraoxystrobin, trifloxystrobin, (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (2E,3Z)-5-{[1-(4-chlorophenyl)-1H-pyrazol-3-yl]oxy}-2-(methoxyimino)-N,3-dimethylpent-3-enamide, (2R)-2-{2-[(2,5-dimethylphenoxy)methyl]phenyl}-2-methoxy-N-methylacetamide, (2S)-2-{2-[(2,5-dimethylphenoxy)methyl]phenyl}-2-methoxy-N-methylacetamide, N-(3-ethyl-3,5,5-trimethylcyclohexyl)-3-formamido-2-hydroxybenzamide, (2E,3Z)-5-{[1-(4-chloro-2-fluorophenyl)-1H-pyrazol-3-yl]oxy}-2-(methoxyimino)-N,3-dimethylpent-3-enamide and methyl {5-[3-(2,4-dimethylphenyl)-1H-pyrazol-1-yl]-2-methylbenzyl}carbamate.

In some preferred embodiments according to the invention, the DHODH inhibitor is used in combination with an inhibitor of the respiratory chain at complex I or II selected from the group consisting of benzovindiflupyr, bixafen, boscalid, carboxin, cyclobutrifluram, flubeneteram, fluindapyr, fluopyram, flutolanil, fluxapyroxad, furametpyr, inpyrfluxam, isofetamid, isoflucypram, isopyrazam, penflufen, penthiopyrad, pydiflumetofen, pyrapropoyne, pyraziflumid, sedaxane, 1,3-dimethyl-N-(1,1,3-trimethyl-2,3-dihydro-1H-inden-4-yl)-1H-pyrazole-4-carboxamide, 1,3-dimethyl-N-[(3R)-1,1,3-trimethyl-2,3-dihydro-1H-inden-4-yl]-1H-pyrazole-4-carboxamide, 1,3-dimethyl-N-[(3S)-1,1,3-trimethyl-2,3-dihydro-1H-inden-4-yl]-1H-pyrazole-4-carboxamide, 1-methyl-3-(trifluoromethyl)-N-[2′-(trifluoromethyl)biphenyl-2-yl]-1H-pyrazole-4-carboxamide, 2-fluoro-6-(trifluoromethyl)-N-(1,1,3-trimethyl-2,3-dihydro-1H-inden-4-yl)benzamide, 3-(difluoromethyl)-1-methyl-N-(1,1,3-trimethyl-2,3-dihydro-1H-inden-4-yl)-1H-pyrazole-4-carboxamide, 3-(difluoromethyl)-1-methyl-N-[(3S)-1,1,3-trimethyl-2,3-dihydro-1H-inden-4-yl]-1H-pyrazole-4-carboxamide, 3-(difluoromethyl)-N-[(3R)-7-fluoro-1,1,3-trimethyl-2,3-dihydro-1H-inden-4-yl]-1-methyl-1H-pyrazole-4-carboxamide, 3-(difluoromethyl)-N-[(3S)-7-fluoro-1,1,3-trimethyl-2,3-dihydro-1H-inden-4-yl]-1-methyl-1H-pyrazole-4-carboxamide, 5,8-difluoro-N-[2-(2-fluoro-4-{[4-(trifluoromethyl)pyridin-2-yl]oxy}phenyl)ethyl]quinazolin-4-amine, N-[(1R,4S)-9-(dichloro-methylene)-1,2,3,4-tetrahydro-1,4-methanonaphthalen-5-yl]-3-(difluoromethyl)-1-methyl-1H-pyrazole-4-carboxamide, N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, N-[1-(2,4-dichlorophenyl)-1-methoxypropan-2-yl]-3-(difluoro-methyl)-1-methyl-1H-pyrazole-4-carboxamide and N-[rac-(1S,2S)-2-(2,4-dichlorophenyl)cyclobutyl]-2-(trifluoromethyl)nicotinamide.

In some other preferred embodiments according to the invention, the DHODH inhibitor is used in combination with an inhibitor of the respiratory chain at complex III selected from the group consisting of ametoctradin, amisulbrom, azoxystrobin, coumethoxystrobin, coumoxystrobin, cyazofamid, dimoxystrobin, enoxastrobin, famoxadone, fenamidone, fenpicoxamid, florylpicoxamid, flufenoxystrobin, fluoxastrobin, kresoxim-methyl, mandestrobin, metarylpicoxamid, metominostrobin, metyltetraprol, orysastrobin, picoxystrobin, pyraclostrobin, pyrametostrobin, pyraoxystrobin, trifloxystrobin, (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (2E,3Z)-5-{[1-(4-chlorophenyl)-1H-pyrazol-3-yl]oxy}-2-(methoxyimino)-N,3-dimethyl-pent-3-enamide, (2R)-2-{2-[(2,5-dimethylphenoxy)methyl]phenyl}-2-methoxy-N-methylacetamide, (2S)-2-{2-[(2,5-dimethylphenoxy)methyl]phenyl}-2-methoxy-N-methylacetamide, N-(3-ethyl-3,5,5-trimethyl-cyclohexyl)-3-formamido-2-hydroxybenzamide, (2E,3Z)-5-{[1-(4-chloro-2-fluorophenyl)-1H-pyrazol-3-yl]oxy}-2-(methoxyimino)-N,3-dimethylpent-3-enamide and methyl {5-[3-(2,4-dimethylphenyl)-1H-pyrazol-1-yl]-2-methylbenzyl}carbamate,

more preferably a quinone-outside inhibitor selected from the group consisting of ametoctradin, azoxystrobin, coumethoxystrobin, coumoxystrobin, dimoxystrobin, enoxastrobin, famoxadone, fenamidone, flufenoxystrobin, fluoxastrobin, kresoxim-methyl, mandestrobin, metominostrobin, metyltetraprole, orysastrobin, picoxystrobin, pyraclostrobin, pyrametostrobin, pyraoxystrobin and trifloxystrobin.

The DHODH inhibitor (component A) and the further fungicide (component B) can be used in a broad range of effective weight ratio of A:B, for example in a range of 5000:1 to 1:5000, preferably in a weight ratio of 1000:1 to 1:1000, more preferably in a weight ratio of 500:1 to 1:500, and most preferably in a weight ratio of 100:1 to 1:100.

The DHODH inhibitor (component A) and the further fungicide (component B) can be applied simultaneously or sequentially.

In some preferred embodiments, the DHODH inhibitor and the further fungicide are applied simultaneously, preferably in form of a composition comprising the DHODH inhibitor and the further fungicide, to the phytopathogenic fungi and/or their habitat.

According to the invention, the DHODH inhibitor is preferably used in form of a composition comprising the DHODH inhibitor, at least one agriculturally suitable auxiliary selected from carriers and surfactants, and optionally a further fungicide as defined above.

A carrier is a solid or liquid, natural or synthetic, organic or inorganic substance that is generally inert. The carrier generally improves the application of the compounds, for instance, to plants, plants parts or seeds. Examples of suitable solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include, but are not limited to crushed and fractionated natural rocks such as calcite, marble, pumice, sepiolite and dolomite, synthetic granules of inorganic and organic flours and granules of organic material such as paper, sawdust, coconut shells, maize cobs and tobacco stalks. Examples of suitable liquid carriers include, but are not limited to, water, organic solvents and combinations thereof. Examples of suitable solvents include polar and nonpolar organic chemical liquids, for example from the classes of aromatic and nonaromatic hydrocarbons (such as cyclohexane, paraffins, alkylbenzenes, xylene, toluene, tetrahydronaphthalene, alkylnaphthalenes, chlorinated aromatics or chlorinated aliphatic hydrocarbons such as chlorobenzenes, chloroethylenes or methylene chloride), alcohols and polyols (which may optionally also be substituted, etherified and/or esterified, such as ethanol, propanol, butanol, benzylalcohol, cyclohexanol or glycol), ketones (such as acetone, methyl ethyl ketone, methyl isobutyl ketone or cyclohexanone), esters (including fats and oils) and (poly)ethers, unsubstituted and substituted amines, amides (such as dimethylformamide or fatty acid amides) and esters thereof, lactams (such as N-alkylpyrrolidones, in particular N-methylpyrrolidone) and lactones, sulfones and sulfoxides (such as dimethyl sulfoxide), oils of vegetable or animal origin. The carrier may also be a liquefied gaseous extender, i.e. liquid which is gaseous at standard temperature and under standard pressure, for example aerosol propellants such as halohydrocarbons, butane, propane, nitrogen and carbon dioxide.

The amount of carrier typically ranges from 1 to 99.99%, preferably from 5 to 99.9%, more preferably from 10 to 99.5%, and most preferably from 20 to 99% by weight of the composition.

If the composition comprises two or more carriers, the outlined ranges refer to the total amount of carriers.

The surfactant can be an ionic (cationic or anionic), amphoteric or non-ionic surfactant, such as ionic or non-ionic emulsifier(s), foam former(s), dispersant(s), wetting agent(s), penetration enhancer(s) and any mixtures thereof. Examples of suitable surfactants include, but are not limited to, salts of polyacrylic acid, salts of lignosulfonic acid (such as sodium lignosulfonate), salts of phenolsulfonic acid or naphthalenesulfonic acid, polycondensates of ethylene oxide and/or propylene oxide with fatty alcohols, fatty acids or fatty amines (for example, polyoxyethylene fatty acid esters such as castor oil ethoxylate, polyoxyethylene fatty alcohol ethers, for example alkylaryl polyglycol ethers), substituted phenols (preferably alkylphenols or arylphenols) and ethoxylates thereof (such as tristyrylphenol ethoxylate), salts of sulfosuccinic esters, taurine derivatives (preferably alkyl taurates), phosphoric esters of polyethoxylated alcohols or phenols, fatty esters of polyols (such a fatty acid esters of glycerol, sorbitol or sucrose), sulfates (such as alkyl sulfates and alkyl ether sulfates), sulfonates (for example, alkylsulfonates, arylsulfonates and alkylbenzene sulfonates), phosphate esters, protein hydrolysates, lignosulfite waste liquors and methylcellulose. Any reference to salts in this paragraph refers preferably to the respective alkali, alkaline earth and ammonium salts.

Preferred surfactants are selected from polyoxyethylene fatty alcohol ethers, polyoxyethylene fatty acid esters, alkylbenzene sulfonates, such as calcium dodecylbenzenesulfonate, castor oil ethoxylate, sodium lignosulfonate and arylphenol ethoxylates, such as tristyrylphenol ethoxylate.

The amount of surfactants typically ranges from 5 to 40%, for example 10 to 20%, by weight of the composition.

Further examples of suitable auxiliaries include water repellents, siccatives, binders (adhesive, tackifier, fixing agent, such as carboxymethylcellulose, natural and synthetic polymers in the form of powders, granules or latices, such as gum arabic, polyvinyl alcohol and polyvinyl acetate, natural phospholipids such as cephalins and lecithins and synthetic phospholipids, polyvinylpyrrolidone and tylose), thickeners and secondary thickeners (such as cellulose ethers, acrylic acid derivatives, xanthan gum, modified clays, e.g. the products available under the name Bentone, and finely divided silica), stabilizers (e.g. cold stabilizers, preservatives (e.g. dichlorophene and benzyl alcohol hemiformal), antioxidants, light stabilizers, in particular UV stabilizers, or other agents which improve chemical and/or physical stability), dyes or pigments (such as inorganic pigments, e.g. iron oxide, titanium oxide and Prussian Blue; organic dyes, e.g. alizarin, azo and metal phthalocyanine dyes), antifoams (e.g. silicone antifoams and magnesium stearate), antifreezes, stickers, gibberellins and processing auxiliaries, mineral and vegetable oils, perfumes, waxes, nutrients (including trace nutrients, such as salts of iron, manganese, boron, copper, cobalt, molybdenum and zinc), protective colloids, thixotropic substances, penetrants, sequestering agents and complex formers.

According to the invention, the DHODH inhibitor (optionally in combination with further active ingredients, in a particular at least one further fungicide as defined above or in form of a composition comprising the DHODH inhibitor and optionally further active ingredients, in a particular at least one further fungicide, as defined above) may be applied to any crop plants (including naturally occurring crop plants) or parts of crop plants. Crop plants may be plants which can be obtained by conventional breeding and optimization methods or by biotechnological and genetic engineering methods or combinations of these methods, including the genetically modified plants (GMO or transgenic plants) and the plant cultivars which are protectable and non-protectable by plant breeders' rights.

Plant cultivars are understood to mean plants which have new properties (“traits”) and have been obtained by conventional breeding, by mutagenesis or by recombinant DNA techniques. They can be cultivars, varieties, bio- or genotypes.

Plant parts are understood to mean all parts and organs of plants above and below the ground, such as shoots, leaves, needles, stalks, stems, flowers, fruit bodies, fruits, seeds, roots, tubers and rhizomes. The plant parts also include harvested material and vegetative and generative propagation material, for example cuttings, tubers, rhizomes, slips and seeds.

The following plants are suitable target crops for applying the DHODH inhibitor according to the present invention (optionally in combination with further active ingredients, in a particular at least one further fungicide as defined above or in form of a composition comprising the DHODH inhibitor and optionally further active ingredients, in a particular at least one further fungicide, as defined above): cereals, for example wheat, barley, rye, oats, rice, maize and millet/sorghum; beet, for example sugar beet and fodder beet; pome fruit, for example apples, pears and quince; stone fruit, for example peaches, nectarines, cherries, plums, common plums and apricots; soft fruit, for example strawberries, raspberries, blackberries and blueberries; citrus fruit, for example oranges, lemons, grapefruit and tangerines; legumes, for example beans, lentils, peas and soybeans; oil crops, for example oilseed rape, mustard, poppies, olives, sunflowers, coconuts, castor oil plants, cacao and peanuts; cucurbits, for example pumpkin/squash, cucumbers and melons; fibre plants, for example cotton, flax, hemp and jute; vegetables, for example spinach, cucumber, lettuce, asparagus, cabbage species, carrots, onions, tomatoes, potatoes and bell peppers; lauraceae, for example avocado, cinnamomum, camphor; and other plants such as turf, tobacco, nuts, coffee, aubergine, sugar cane, tea, pepper, grapevines, table grapes, hops, bananas, latex plants and ornamentals, for example flowers, shrubs, deciduous trees and coniferous trees.

In some embodiments according to the invention, the target crops are cereals, preferably selected from the group consisting of wheat, barley, rye, oats, rice, maize and millet/sorghum, more preferably wheat and barley.

In some other embodiments according to the invention, the target crops are selected from the group consisting of pome fruit, for example apples, pears and quince; stone fruit, for example peaches, nectarines, cherries, plums, common plums and apricots; soft fruit, for example strawberries, raspberries, blackberries and blueberries; citrus fruit, for example oranges, lemons, grapefruit and tangerines; vegetables, for example spinach, cucumber, lettuce, asparagus, cabbage species, carrots, onions, tomatoes, potatoes and bell peppers; peppers, grapevines, table grapes, bananas, melons, hops and ornamentals, for example roses.

Plants and plant cultivars which may be treated with the DHODH inhibitor according to the invention include plants and plant cultivars which are resistant against one or more biotic stresses, i.e. said plants show a better defense against animal and microbial pests, such as against nematodes, insects, mites, phytopathogenic fungi, bacteria, viruses and/or viroids.

Plants and plant cultivars which may be treated with the DHODH inhibitor according to the invention include those plants which are resistant to one or more abiotic stresses. Abiotic stress conditions may include, for example, drought, cold temperature exposure, heat exposure, osmotic stress, flooding, increased soil salinity, increased mineral exposure, ozone exposure, high light exposure, limited availability of nitrogen nutrients, limited availability of phosphorus nutrients, shade avoidance.

Plants and plant cultivars which may be treated with the DHODH inhibitor according to the invention include those plants characterized by enhanced yield characteristics. Increased yield in said plants may be the result of, for example, improved plant physiology, growth and development, such as water use efficiency, water retention efficiency, improved nitrogen use, enhanced carbon assimilation, improved photosynthesis, increased germination efficiency and accelerated maturation. Yield may furthermore be affected by improved plant architecture (under stress and non-stress conditions), including but not limited to, early flowering, flowering control for hybrid seed production, seedling vigor, plant size, internode number and distance, root growth, seed size, fruit size, pod size, pod or ear number, seed number per pod or ear, seed mass, enhanced seed filling, reduced seed dispersal, reduced pod dehiscence and lodging resistance. Further yield traits include seed composition, such as carbohydrate content and composition for example cotton or starch, protein content, oil content and composition, nutritional value, reduction in anti-nutritional compounds, improved processability and better storage stability.

Plants and plant cultivars which may be treated with the DHODH inhibitor according to the invention include plants and plant cultivars which are hybrid plants that already express the characteristic of heterosis or hybrid vigor which results in generally higher yield, vigor, health and resistance towards biotic and abiotic stresses.

According to the invention, the DHODH inhibitor can be advantageously used to treat transgenic plants, plant cultivars or plant parts that received genetic material which imparts advantageous and/or useful properties (traits) to these plants, plant cultivars or plant parts. Therefore, it is contemplated that the present invention may be combined with one or more recombinant traits or transgenic event(s) or a combination thereof. For the purposes of this application, a transgenic event is created by the insertion of a specific recombinant DNA molecule into a specific position (locus) within the chromosome of the plant genome. The insertion creates a novel DNA sequence referred to as an “event” and is characterized by the inserted recombinant DNA molecule and some amount of genomic DNA immediately adjacent to/flanking both ends of the inserted DNA. Such trait(s) or transgenic event(s) include, but are not limited to, pest resistance, water use efficiency, yield performance, drought tolerance, seed quality, improved nutritional quality, hybrid seed production, and herbicide tolerance, in which the trait is measured with respect to a plant lacking such trait or transgenic event. Concrete examples of such advantageous and/or useful properties (traits) are better plant growth, vigor, stress tolerance, standability, lodging resistance, nutrient uptake, plant nutrition, and/or yield, in particular improved growth, increased tolerance to high or low temperatures, increased tolerance to drought or to levels of water or soil salinity, enhanced flowering performance, easier harvesting, accelerated ripening, higher yields, higher quality and/or a higher nutritional value of the harvested products, better storage life and/or processability of the harvested products, and increased resistance against animal and microbial pests, such as against insects, arachnids, nematodes, mites, slugs and snails.

Among DNA sequences encoding proteins which confer properties of tolerance to such animal and microbial pests, in particular insects, mention will particularly be made of the genetic material from Bacillus thuringiensis encoding the Bt proteins widely described in the literature and well known to those skilled in the art. Mention will also be made of proteins extracted from bacteria such as Photorhabdus (WO97/17432 and WO98/08932). In particular, mention will be made of the Bt Cry or VIP proteins which include the CrylA, CryIAb, CryIAc, CryIIA, CryIIIA, CryIIIB2, Cry9c Cry2Ab, Cry3Bb and CryIF proteins or toxic fragments thereof and also hybrids or combinations thereof, especially the CrylF protein or hybrids derived from a CrylF protein (e.g. hybrid CrylA-CrylF proteins or toxic fragments thereof), the CrylA-type proteins or toxic fragments thereof, preferably the CrylAc protein or hybrids derived from the CrylAc protein (e.g. hybrid CrylAb-CrylAc proteins) or the CrylAb or Bt2 protein or toxic fragments thereof, the Cry2Ae, Cry2Af or Cry2Ag proteins or toxic fragments thereof, the CrylA.105 protein or a toxic fragment thereof, the VIP3Aa19 protein, the VIP3Aa20 protein, the VIP3A proteins produced in the COT202 or COT203 cotton events, the VIP3Aa protein or a toxic fragment thereof as described in Estruch et al. (1996), Proc Natl Acad Sci USA. 28; 93(11):5389-94, the Cry proteins as described in WO2001/47952, the insecticidal proteins from Xenorhabdus (as described in WO98/50427), Serratia (particularly from S. entomophila) or Photorhabdus species strains, such as Tc-proteins from Photorhabdus as described in WO98/08932. Also any variants or mutants of any one of these proteins differing in some amino acids (1-10, preferably 1-5) from any of the above named sequences, particularly the sequence of their toxic fragment, or which are fused to a transit peptide, such as a plastid transit peptide, or another protein or peptide, is included herein.

Another and particularly emphasized example of such properties is conferred tolerance to one or more herbicides, for example imidazolinones, sulphonylureas, glyphosate or phosphinothricin. Among DNA sequences encoding proteins which confer properties of tolerance to certain herbicides on the transformed plant cells and plants, mention will be particularly be made to the bar or PAT gene or the Streptomyces coelicolor gene described in WO2009/152359 which confers tolerance to glufosinate herbicides, a gene encoding a suitable EPSPS (5-Enolpyruvylshikimat-3-phosphat-synthase) which confers tolerance to herbicides having EPSPS as a target, especially herbicides such as glyphosate and its salts, a gene encoding glyphosate-n-acetyltransferase, or a gene encoding glyphosate oxidoreductase. Further suitable herbicide tolerance traits include at least one ALS (acetolactate synthase) inhibitor (e.g. WO2007/024782), a mutated Arabidopsis ALS/AHAS gene (e.g. U.S. Pat. No. 6,855,533), genes encoding 2,4-D-monooxygenases conferring tolerance to 2,4-D (2,4-dichlorophenoxyacetic acid) and genes encoding Dicamba monooxygenases conferring tolerance to dicamba (3,6-dichloro-2-methoxybenzoic acid).

Yet another example of such properties is resistance to one or more phytopathogenic fungi, for example Asian Soybean Rust. Among DNA sequences encoding proteins which confer properties of resistance to such diseases, mention will particularly be made of the genetic material from Glycine tomentella, for example from any one of publically available accession lines PI441001, PI483224, PI583970, PI446958, PI499939, PI505220, PI499933, PI441008, PI505256 or PI446961 as described in WO2019/103918.

Further and particularly emphasized examples of such properties are increased resistance against bacteria and/or viruses owing, for example, to systemic acquired resistance (SAR), systemin, phytoalexins, elicitors and also resistance genes and correspondingly expressed proteins and toxins.

Particularly useful transgenic events in transgenic plants or plant cultivars which can be treated with preference in accordance with the invention include Event 531/PV-GHBK04 (cotton, insect control, described in WO2002/040677), Event 1143-14A (cotton, insect control, not deposited, described in WO2006/128569); Event 1143-51B (cotton, insect control, not deposited, described in WO2006/128570); Event 1445 (cotton, herbicide tolerance, not deposited, described in US-A 2002-120964 or WO2002/034946); Event 17053 (rice, herbicide tolerance, deposited as PTA-9843, described in WO2010/117737); Event 17314 (rice, herbicide tolerance, deposited as PTA-9844, described in WO2010/117735); Event 281-24-236 (cotton, insect control—herbicide tolerance, deposited as PTA-6233, described in WO2005/103266 or US-A 2005-216969); Event 3006-210-23 (cotton, insect control—herbicide tolerance, deposited as PTA-6233, described in US-A 2007-143876 or WO2005/103266); Event 3272 (corn, quality trait, deposited as PTA-9972, described in WO2006/098952 or US-A 2006-230473); Event 33391 (wheat, herbicide tolerance, deposited as PTA-2347, described in WO2002/027004), Event 40416 (corn, insect control—herbicide tolerance, deposited as ATCC PTA-11508, described in WO 11/075593); Event 43A47 (corn, insect control—herbicide tolerance, deposited as ATCC PTA-11509, described in WO2011/075595); Event 5307 (corn, insect control, deposited as ATCC PTA-9561, described in WO2010/077816); Event ASR-368 (bent grass, herbicide tolerance, deposited as ATCC PTA-4816, described in US-A 2006-162007 or WO2004/053062); Event B16 (corn, herbicide tolerance, not deposited, described in US-A 2003-126634); Event BPS-CV127-9 (soybean, herbicide tolerance, deposited as NCIMB No. 41603, described in WO2010/080829); Event BLR1 (oilseed rape, restoration of male sterility, deposited as NCIMB 41193, described in WO2005/074671), Event CE43-67B (cotton, insect control, deposited as DSM ACC2724, described in US-A 2009-217423 or WO2006/128573); Event CE44-69D (cotton, insect control, not deposited, described in US-A 2010-0024077); Event CE44-69D (cotton, insect control, not deposited, described in WO2006/128571); Event CE46-02A (cotton, insect control, not deposited, described in WO2006/128572); Event COT102 (cotton, insect control, not deposited, described in US-A 2006-130175 or WO2004/039986); Event COT202 (cotton, insect control, not deposited, described in US-A 2007-067868 or WO2005/054479); Event COT203 (cotton, insect control, not deposited, described in WO2005/054480);); Event DAS21606-3/1606 (soybean, herbicide tolerance, deposited as PTA-11028, described in WO2012/033794), Event DAS40278 (corn, herbicide tolerance, deposited as ATCC PTA-10244, described in WO2011/022469); Event DAS-44406-6/pDAB8264.44.06.1 (soybean, herbicide tolerance, deposited as PTA-11336, described in WO2012/075426), Event DAS-14536-7/pDAB8291.45.36.2 (soybean, herbicide tolerance, deposited as PTA-11335, described in WO2012/075429), Event DAS-59122-7 (corn, insect control—herbicide tolerance, deposited as ATCC PTA 11384, described in US-A 2006-070139); Event DAS-59132 (corn, insect control—herbicide tolerance, not deposited, described in WO2009/100188); Event DAS68416 (soybean, herbicide tolerance, deposited as ATCC PTA-10442, described in WO2011/066384 or WO2011/066360); Event DP-098140-6 (corn, herbicide tolerance, deposited as ATCC PTA-8296, described in US-A 2009-137395 or WO 08/112019); Event DP-305423-1 (soybean, quality trait, not deposited, described in US-A 2008-312082 or WO2008/054747); Event DP-32138-1 (corn, hybridization system, deposited as ATCC PTA-9158, described in US-A 2009-0210970 or WO2009/103049); Event DP-356043-5 (soybean, herbicide tolerance, deposited as ATCC PTA-8287, described in US-A 2010-0184079 or WO2008/002872); Event EE-I (brinjal, insect control, not deposited, described in WO 07/091277); Event Fil 17 (corn, herbicide tolerance, deposited as ATCC 209031, described in US-A 2006-059581 or WO 98/044140); Event FG72 (soybean, herbicide tolerance, deposited as PTA-11041, described in WO2011/063413), Event GA21 (corn, herbicide tolerance, deposited as ATCC 209033, described in US-A 2005-086719 or WO 98/044140); Event GG25 (corn, herbicide tolerance, deposited as ATCC 209032, described in US-A 2005-188434 or WO98/044140); Event GHB119 (cotton, insect control—herbicide tolerance, deposited as ATCC PTA-8398, described in WO2008/151780); Event GHB614 (cotton, herbicide tolerance, deposited as ATCC PTA-6878, described in US-A 2010-050282 or WO2007/017186); Event GJ11 (corn, herbicide tolerance, deposited as ATCC 209030, described in US-A 2005-188434 or WO98/044140); Event GM RZ13 (sugar beet, virus resistance, deposited as NCIMB-41601, described in WO2010/076212); Event H7-1 (sugar beet, herbicide tolerance, deposited as NCIMB 41158 or NCIMB 41159, described in US-A 2004-172669 or WO 2004/074492); Event JOPLIN1 (wheat, disease tolerance, not deposited, described in US-A 2008-064032); Event LL27 (soybean, herbicide tolerance, deposited as NCIMB41658, described in WO2006/108674 or US-A 2008-320616); Event LL55 (soybean, herbicide tolerance, deposited as NCIMB 41660, described in WO 2006/108675 or US-A 2008-196127); Event LLcotton25 (cotton, herbicide tolerance, deposited as ATCC PTA-3343, described in WO2003/013224 or US-A 2003-097687); Event LLRICE06 (rice, herbicide tolerance, deposited as ATCC 203353, described in U.S. Pat. No. 6,468,747 or WO2000/026345); Event LLRice62 (rice, herbicide tolerance, deposited as ATCC 203352, described in WO2000/026345), Event LLRICE601 (rice, herbicide tolerance, deposited as ATCC PTA-2600, described in US-A 2008-2289060 or WO2000/026356); Event LY038 (corn, quality trait, deposited as ATCC PTA-5623, described in US-A 2007-028322 or WO2005/061720); Event MIR162 (corn, insect control, deposited as PTA-8166, described in US-A 2009-300784 or WO2007/142840); Event MIR604 (corn, insect control, not deposited, described in US-A 2008-167456 or WO2005/103301); Event MON15985 (cotton, insect control, deposited as ATCC PTA-2516, described in US-A 2004-250317 or WO2002/100163); Event MON810 (corn, insect control, not deposited, described in US-A 2002-102582); Event MON863 (corn, insect control, deposited as ATCC PTA-2605, described in WO2004/011601 or US-A 2006-095986); Event MON87427 (corn, pollination control, deposited as ATCC PTA-7899, described in WO2011/062904); Event MON87460 (corn, stress tolerance, deposited as ATCC PTA-8910, described in WO2009/111263 or US-A 2011-0138504); Event MON87701 (soybean, insect control, deposited as ATCC PTA-8194, described in US-A 2009-130071 or WO2009/064652); Event MON87705 (soybean, quality trait—herbicide tolerance, deposited as ATCC PTA-9241, described in US-A 2010-0080887 or WO2010/037016); Event MON87708 (soybean, herbicide tolerance, deposited as ATCC PTA-9670, described in WO2011/034704); Event MON87712 (soybean, yield, deposited as PTA-10296, described in WO2012/051199), Event MON87754 (soybean, quality trait, deposited as ATCC PTA-9385, described in WO2010/024976); Event MON87769 (soybean, quality trait, deposited as ATCC PTA-8911, described in US-A 2011-0067141 or WO2009/102873); Event MON88017 (corn, insect control—herbicide tolerance, deposited as ATCC PTA-5582, described in US-A 2008-028482 or WO2005/059103); Event MON88913 (cotton, herbicide tolerance, deposited as ATCC PTA-4854, described in WO2004/072235 or US-A 2006-059590); Event MON88302 (oilseed rape, herbicide tolerance, deposited as PTA-10955, described in WO2011/153186), Event MON88701 (cotton, herbicide tolerance, deposited as PTA-11754, described in WO2012/134808), Event MON89034 (corn, insect control, deposited as ATCC PTA-7455, described in WO 07/140256 or US-A 2008-260932); Event MON89788 (soybean, herbicide tolerance, deposited as ATCC PTA-6708, described in US-A 2006-282915 or WO2006/130436); Event MSl 1 (oilseed rape, pollination control—herbicide tolerance, deposited as ATCC PTA-850 or PTA-2485, described in WO2001/031042); Event MS8 (oilseed rape, pollination control—herbicide tolerance, deposited as ATCC PTA-730, described in WO2001/041558 or US-A 2003-188347); Event NK603 (corn, herbicide tolerance, deposited as ATCC PTA-2478, described in US-A 2007-292854); Event PE-7 (rice, insect control, not deposited, described in WO2008/114282); Event RF3 (oilseed rape, pollination control—herbicide tolerance, deposited as ATCC PTA-730, described in WO2001/041558 or US-A 2003-188347); Event RT73 (oilseed rape, herbicide tolerance, not deposited, described in WO2002/036831 or US-A 2008-070260); Event SYHTOH2/SYN-000H2-5 (soybean, herbicide tolerance, deposited as PTA-11226, described in WO2012/082548), Event T227-1 (sugar beet, herbicide tolerance, not deposited, described in WO2002/44407 or US-A 2009-265817); Event T25 (corn, herbicide tolerance, not deposited, described in US-A 2001-029014 or WO2001/051654); Event T304-40 (cotton, insect control—herbicide tolerance, deposited as ATCC PTA-8171, described in US-A 2010-077501 or WO2008/122406); Event T342-142 (cotton, insect control, not deposited, described in WO2006/128568); Event TC1507 (corn, insect control—herbicide tolerance, not deposited, described in US-A 2005-039226 or WO2004/099447); Event VIP1034 (corn, insect control—herbicide tolerance, deposited as ATCC PTA-3925, described in WO2003/052073), Event 32316 (corn, insect control-herbicide tolerance, deposited as PTA-11507, described in WO2011/084632), Event 4114 (corn, insect control-herbicide tolerance, deposited as PTA-11506, described in WO2011/084621), event EE-GM3/FG72 (soybean, herbicide tolerance, ATCC Accession No PTA-11041) optionally stacked with event EE-GM1/LL27 or event EE-GM2/LL55 (WO2011/063413A2), event DAS-68416-4 (soybean, herbicide tolerance, ATCC Accession No PTA-10442, WO2011/066360A1), event DAS-68416-4 (soybean, herbicide tolerance, ATCC Accession No PTA-10442, WO2011/066384A1), event DP-040416-8 (corn, insect control, ATCC Accession No PTA-11508, WO2011/075593A1), event DP-043A47-3 (corn, insect control, ATCC Accession No PTA-11509, WO2011/075595A1), event DP-004114-3 (corn, insect control, ATCC Accession No PTA-11506, WO2011/084621A1), event DP-032316-8 (corn, insect control, ATCC Accession No PTA-11507, WO2011/084632A1), event MON-88302-9 (oilseed rape, herbicide tolerance, ATCC Accession No PTA-10955, WO2011/153186A1), event DAS-21606-3 (soybean, herbicide tolerance, ATCC Accession No. PTA-11028, WO2012/033794A2), event MON-87712-4 (soybean, quality trait, ATCC Accession No. PTA-10296, WO2012/051199A2), event DAS-44406-6 (soybean, stacked herbicide tolerance, ATCC Accession No. PTA-11336, WO2012/075426A1), event DAS-14536-7 (soybean, stacked herbicide tolerance, ATCC Accession No. PTA-11335, WO2012/075429A1), event SYN-000H2-5 (soybean, herbicide tolerance, ATCC Accession No. PTA-11226, WO2012/082548A2), event DP-061061-7 (oilseed rape, herbicide tolerance, no deposit N° available, WO2012071039A1), event DP-073496-4 (oilseed rape, herbicide tolerance, no deposit N° available, US2012131692), event 8264.44.06.1 (soybean, stacked herbicide tolerance, Accession N° PTA-11336, WO2012075426A2), event 8291.45.36.2 (soybean, stacked herbicide tolerance, Accession No. PTA-11335, WO2012075429A2), event SYHTOH2 (soybean, ATCC Accession No. PTA-11226, WO2012/082548A2), event MON88701 (cotton, ATCC Accession No PTA-11754, WO2012/134808A1), event KK179-2 (alfalfa, ATCC Accession No PTA-11833, WO2013/003558A1), event pDAB8264.42.32.1 (soybean, stacked herbicide tolerance, ATCC Accession No PTA-11993, WO2013/010094A1), event MZDT09Y (corn, ATCC Accession No PTA-13025, WO2013/012775A1).

Further, a list of such transgenic event(s) is provided by the United States Department of Agriculture's (USDA) Animal and Plant Health Inspection Service (APHIS) and can be found on their website on the world wide web at aphis.usda.gov. For this application, the status of such list as it is/was on the filing date of this application, is relevant.

The genes/events which impart the desired traits in question may also be present in combinations with one another in the transgenic plants. Examples of transgenic plants which may be mentioned are the important crop plants, such as cereals (wheat, rice, triticale, barley, rye, oats), maize, soya beans, potatoes, sugar beet, sugar cane, tomatoes, peas and other types of vegetable, cotton, tobacco, oilseed rape and also fruit plants (with the fruits apples, pears, citrus fruits and grapes), with particular emphasis being given to maize, soya beans, wheat, rice, potatoes, cotton, sugar cane, tobacco and oilseed rape. Traits which are particularly emphasized are the increased resistance of the plants to insects, arachnids, nematodes and slugs and snails, as well as the increased resistance of the plants to one or more herbicides.

Commercially available examples of such plants, plant parts or plant seeds that may be treated with preference in accordance with the invention include commercial products, such as plant seeds, sold or distributed under the GENUITY®, DROUGHTGARD®, SMARTSTAX®, RIB COMPLETE®, ROUNDUP READY®, VT DOUBLE PRO®, VT TRIPLE PRO®, BOLLGARD II®, ROUNDUP READY 2 YIELD®, YIELDGARD®, ROUNDUP READY® 2 XTEND™, INTACTA RR2 PRO®, VISTIVE GOLD®, and/or XTENDFLEX™ trade names.

The present invention also relates to a method for controlling phytopathogenic fungi in crops which comprises the step of applying a dihydroorotate dehydrogenase (DHODH) inhibitor as defined above to the phytopathogenic fungi and/or their habitat (to the plants, plant parts, seeds, fruits and/or to the soil in which the plants grow).

The DHODH inhibitor used according to the invention can be applied as such, or for example in the form of as ready-to-use solutions, emulsions, water- or oil-based suspensions, powders, wettable powders, pastes, soluble powders, dusts, soluble granules, granules for broadcasting, suspoemulsion concentrates, natural products impregnated with the DHODH inhibitor, synthetic substances impregnated with the DHODH inhibitor, fertilizers or microencapsulations in polymeric substances.

Application is accomplished in a customary manner, for example by watering, spraying, atomizing, broadcasting, dusting, foaming or spreading-on. It is also possible to deploy the DHODH inhibitor by the ultra-low volume method, via a drip irrigation system or drench application, to apply it in-furrow or to inject it into the soil stem or trunk. It is further possible to apply the DHODH inhibitor by means of a wound seal, paint or other wound dressing.

Typically, when the DHODH inhibitor is used in a curative or protective method for controlling phytopathogenic fungi according to the invention, a fungicidally effective and plant-compatible amount thereof is applied to the plants, plant parts, fruits, seeds or to the soil or substrates in which the plants grow. Suitable substrates that may be used for cultivating plants include inorganic based substrates, such as mineral wool, in particular stone wool, perlite, sand or gravel; organic substrates, such as peat, pine bark or sawdust; and petroleum based substrates such as polymeric foams or plastic beads. Fungicidally effective and plant-compatible amount means an amount that is sufficient to control or destroy the fungi present or liable to appear on the cropland and that does not entail any appreciable symptom of phytotoxicity for said crops. Such an amount can vary within a wide range depending on the fungus to be controlled, the type of crop, the crop growth stage, the climatic conditions and the composition used. This amount can be determined by systematic field trials that are within the capabilities of a person skilled in the art.

Typically, for the treatment of plant parts, such as leaves, the application rate may range from 0.1 to 10 000 g/ha, preferably from 10 to 1000 g/ha, more preferably from 50 to 300 g/ha (in the case of application by watering or dripping, it is even possible to reduce the application rate, especially when inert substrates such as rockwool or perlite are used). For the treatment of seeds, the application rate may typically range from 0.1 to 200 g per 100 kg of seeds, preferably from 1 to 150 g per 100 kg of seeds, more preferably from 2.5 to 25 g per 100 kg of seeds, even more preferably from 2.5 to 12.5 g per 100 kg of seeds. For the treatment of soil, the application rate may range from 0.1 to 10 000 g/ha, preferably from 1 to 5000 g/ha.

The period for which control of the phytopathogenic fungi is provided extends typically for 1 to 28 days, preferably for 1 to 14 days, more preferably for 1 to 10 days, most preferably for 1 to 7 days, after the treatment of the plants, or for up to 200 days after a seed treatment.

In some preferred embodiments, the method according to the invention further comprises the step of applying at least one further fungicide selected from inhibitors of the respiratory chain at complex I or II as defined above and inhibitors of the respiratory chain at complex III as defined above to the phytopathogenic fungi and/or their habitat. The DHODH inhibitor and the further fungicide may be applied simultaneously or sequentially.

In some preferred embodiments of the method according to the invention, the DHODH inhibitor and the further fungicide are applied simultaneously, preferably in form of a composition comprising the DHODH inhibitor and the further fungicide, to the phytopathogenic fungi and/or their habitat.

The invention is illustrated by the examples below. However, the invention is not limited to the examples.

### Example: Cell-Tests with Zymoseptoria tritici Strains

Pathogen: Zymoseptoria tritici (SEPTTR)

The following Zymoseptoria tritici strains were used:

| No. | sampling date | country | region | location/site |
|---|---|---|---|---|
| D01/16 | 1 Jul. 2015 | Great Britain | East Midlands | Paulerspury |
| D02/16 | 17 Jun. 2015 | Ireland | Leinster | Kilkenny-Goresbridge |
| D03/16 | 7 Jul. 2015 | Ireland | Munster | Watergrasshill |
| D04/16 | 1 Jul. 2015 | Great Britain | East Midlands | Paulerspury |
| D05/16 | 7 Jul. 2015 | Ireland | Munster | Watergrasshill |
| D06/16 | 20 Apr. 2015 | Germany | Saxony-Anhalt | Danstedt |
| D07/16 | 27 Jun. 2015 | France | Hauts-de-France | Bonniers |
| D08/16 | 10 Jun. 2015 | France | Île-de-France | Chars |
| D09/16 | 17 Jun. 2015 | France | Hauts-de-France | Courmont |
| D13/16 | 10 Jun. 2015 | Ireland | Munster | Liscarroll |
| D14/16 | 7 May 2015 | Austria | unknown | unknown |
| D19/16 | reference isolate | | | |
| D20/16 | reference isolate | | | |
| D22/16 | reference isolate | | | |
| M02/15 | reference isolate | | | |

The main cause for QoI resistance in Zymoseptoria tritici strains is a single nucleotide polymorphism (SNP) in the fungal cytochrome b gene leading to an amino acid substitution of glycine with alanine at position 143 of the cytochrome b protein. The level of resistance (percentage of mutation G143A) in the above-referenced Zymoseptoria leaf spot samples was determined using the following molecular-biological pyrosequencing method:

### Sampling and DNA Extraction:

Around twenty randomly sampled leaves represent one sample. From each leaf per sample, typical Zymoseptoria leaf spot lesions (0 approx. 1.5 mm) are cut out with a cork-borer and pooled in a 50 ml Falcon-tube. For DNA extraction, the plant material is mixed with Lysis buffer (RLT Buffer) and homogenized via stirring with satellite spheres of different sizes at 4500 rpm for 3×20 minutes with a 60″ break between the single homogenization steps. After mechanical disruption and centrifugation at 11.000 rpm for 10 minutes, 200 μl of the supernatant are used for DNA purification according to the BioSprint DNA Plant Kit procedure (Qiagen).

### PCR and Pyrosequencing:

2.5 μl of purified DNA are used for amplification of the cytochrome b gene fragment in a hot start PCR containing: 12.5 μl HotStarTaq Mastermix (Qiagen), 0.5 μl of primer SEPTTR-G143A-F1: GATGATGGCAACCGCATTCTTAG (10 μM), 0.5 μl of primer SEPTTR-G143A-R1B: ACTATGTCTTGTCCAACTCAAGG (10 μM), and 6 μl H₂O dest. The PCR conditions are as follows: 15′ at 95° C. followed by 94° C. for 30″, 59° C. for 30″ and 72° C. for 1′ with 39 cycles, and final elongation at 72° C. for 10′. For the detection of the G143A mutation the PCR product is analyzed by pyrosequencing using the following specific sequencing primer (SEPTTR-G143A-S1: TGGTCAAATGTCTTTATGAG), according to the manufactures' instructions (Qiagen). Specific software calculates the allele frequency at the position of the mutation, thus indicating the percentage of G143 mutated fragments within the pooled DNA samples.

### Test Compounds

### Azoxystrobin (CAS No. 131860-33-8)

### Ipflufenoquin (CAS No. 1314008-27-9)

### Quinofumelin (CAS No. 861647-84-9)

### Compound (I):

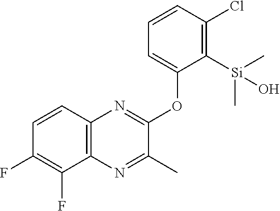 [SMILES: Cc1nc2c(F)c(F)ccc2nc1Oc1cccc(Cl)c1[Si](C)(C)O]

Wells of 96-well microtiter plates are filled with 10 μl of different concentrations of a preparation of test compound in methanol. Thereafter, the solvent is evaporated in a hood. At the next step, into each well 100 μl of liquid growth medium is given, that has been amended with an appropriate concentration of spores of Zymoseptoria tritici.

With the aid of a photometer the extinction in all wells is measured at the wavelength of 620 nm.

The microtiter plates are incubated for 3 to 5 days at 20° C. and 85% relative humidity. After the incubation inhibition of growth is determined again photometrically at 620 nm. Based on the Δ extinction data in relation to the untreated test organism (control) efficacies of growth inhibition are determined. From the different test concentrations a dose-response curve and the resulting ED50 (effective dose of 50% inhibition) is calculated.

| | | | | | % Mutation |
|---|---|---|---|---|---|
| SEPTTR | azoxistrobin | quinofumelin | compound (I) | ipflufenoquin | cytB G143A |
| D01/16 | 24.6765 | 4.6903 | 5.0612 | 0.6923 | 100 |
| D02/16 | 9.0142 | 0.2398 | 0.9987 | 0.0394 | 100 |
| D03/16 | 26.4593 | 0.0006 | 0.5019 | 0.0006 | 100 |
| D04/16 | 8.1601 | 2.5033 | 13.6070 | 0.9849 | 100 |
| D05/16 | 16.9327 | 5.5934 | 6.5728 | 3.0398 | 100 |
| D06/16 | 4.5692 | 0.7694 | 1.3205 | 0.0022 | 100 |
| D07/16 | 7.6229 | 0.3807 | 0.3446 | 0.0178 | 100 |
| D08/16 | 4.3631 | 0.5426 | 0.5545 | 0.0619 | 100 |
| D09/16 | 3.8142 | 0.6997 | 0.7629 | 0.0588 | 100 |
| D13/16 | 25.7640 | 50.0000 | 50.0000 | 37.7428 | 100 |
| D14/16 | 0.0793 | 50.0000 | 50.0000 | 3.2123 | 0 |
| D19/16 | 0.1676 | 50.0000 | 50.0000 | 25.3184 | 0 |
| D20/16 | 0.2417 | 24.4349 | 2.7770 | 1.1062 | 0 |
| D22/16 | 0.0826 | 50.0000 | 46.6905 | 25.0003 | 0 |
| M02/15 | 0.0464 | 50.0000 | 48.3560 | 41.8170 | 0 |

It becomes evident from the experimental data that DHODH inhibitors are generally highly active, especially against Septoria strains, in particular strobilurin-resistant Septoria strains carrying the G143A mutation.

It further becomes evident from the experimental data that the growth of strobilurin-resistant Septoria strains carrying the G143A mutation can be controlled with significantly lower concentrations of fungicides inhibiting the dihydroorotate dehydrogenase than the growth of fungal isolates that are susceptible to respiration inhibitors.

What is claims is:

1. A method for controlling at least one phytopathogenic fungus in crops, the method comprising use of a dihydroorotate dehydrogenase (DHODH) inhibitor, wherein the at least one phytopathogenic fungus contains a mutation in a mitochondrial cytochrome b gene conferring resistance to quinone-outside inhibitors (QoI).

2. The method according to claim 1, wherein the DHODH inhibitor is ipflufenoquin.

3. (canceled)

4. The method according to claim 1, wherein the mutation is selected from the group consisting of a G143A mutation and a F129L mutation.

5. The method according to claim 4, wherein the mutation is a G143A mutation.

6. The method according to claim 1, wherein the at least one phytopathogenic fungus is selected from the group consisting of Monographella nivalis, Botrytis cinerea, Pyricularia oryzae, Septoria glycines, Cercospora kikuchii, Cercospora sojina, Rhizoctonia solani, Phakopsora pachyrhizi, Corynespora cassiicola, Blumeria graminis, Sphaerotheca fuliginea, Erysiphe necator, Alternaria solani, Cercospora beticola, Guignardia bidwellii, Magnaporthe grisea, Microdochium nivale, Zymoseptoria tritici, Mycosphaerella fijiensis, Phaeosphaeria nodorum, Pyrenophora teres, Pyrenophora tritici repentis, Ramularia collo-cygni, Ramularia areola, Rhynchosporium secalis, Venturia inaequalis, Monilinia laxa and Sclerotinia sclerotiorum.

7. The method according to claim 6, wherein the at least one phytopathogenic fungus is Zymoseptoria tritici.

8. The method according to claim 1, wherein the crops are selected from the group consisting of wheat, barley, rye, oats, rice, maize, millet/sorghum, sugar beet, fodder beet, apples, pears, quince, peaches, nectarines, cherries, plums, common plums, apricots, strawberries, raspberries, blackberries, blueberries, oranges, lemons, grapefruit, tangerines, beans, lentils, peas, soybeans, oilseed rape, mustard, poppies, olives, sunflowers, coconuts, castor oil plants, cacao, peanuts, pumpkin/squash, cucumbers, melons, cotton, flax, hemp, jute, spinach, lettuce, asparagus, cabbage species, carrots, onions, tomatoes, potatoes, bell peppers, avocado, cinnamomum, camphor, turf, tobacco, nuts, coffee, aubergine, sugar cane, tea, pepper, grapevines, table grapes, hops, bananas, latex plants flowers, shrubs, deciduous trees and coniferous trees.

9. The method according to claim 8, wherein the crops are selected from the group consisting of wheat, barley, rye, oats, rice, maize, sugar beet, apples, pears, quince, peaches, nectarines, cherries, plums, common plums, apricots, strawberries, raspberries, blackberries, blueberries, pumpkin/squash, cucumbers, melons, cotton, spinach, lettuce, cabbage species, carrots, onions, tomatoes, potatoes, bell peppers, nuts, grapevines, table grapes, hops and bananas.

10. The method according to claim 1, further comprising use of a respiratory chain inhibitor selected from the group consisting of ametoctradin, amisulbrom, azoxystrobin, coumethoxystrobin, coumoxystrobin, cyazofamid, dimoxystrobin, enoxastrobin, famoxadone, fenamidone, fenpicoxamid, florylpicoxamid, flufenoxystrobin, fluoxastrobin, kresoxim-methyl, mandestrobin, metarylpicoxamid, metominostrobin, metyltetraprol, orysastrobin, picoxystrobin, pyraclostrobin, pyrametostrobin, pyraoxystrobin, trifloxystrobin, (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (2E,3Z)-5-{[1-(4-chlorophenyl)-1H-pyrazol-3-yl]oxy}-2-(methoxyimino)-N,3-dimethylpent-3-enamide, (2R)-2-{2-[(2,5-dimethylphenoxy)methyl]phenyl}-2-methoxy-N-methylacetamide, (2S)-2-{2-[(2,5-dimethylphenoxy)methyl]phenyl}-2-methoxy-N-methylacetamide, N-(3-ethyl-3,5,5-trimethylcyclohexyl)-3-formamido-2-hydroxybenzamide, (2E,3Z)-5-{[1-(4-chloro-2-fluorophenyl)-1H-pyrazol-3-yl]oxy}-2-(methoxyimino)-N,3-dimethylpent-3-enamide and methyl {5-[3-(2,4-dimethylphenyl)-1H-pyrazol-1-yl]-2-methylbenzyl}carbamate, wherein the respiratory chain inhibitor inhibits a respiratory chain at complex III.

11. The method according to claim 10, wherein the respiratory chain inhibitor is a quinone-outside inhibitor selected from the group consisting of ametoctradin, azoxystrobin, coumethoxystrobin, coumoxystrobin, dimoxystrobin, enoxastrobin, famoxadone, fenamidone, flufenoxystrobin, fluoxastrobin, kresoxim-methyl, mandestrobin, metominostrobin, orysastrobin, picoxystrobin, pyraclostrobin, pyrametostrobin, pyraoxystrobin and trifloxystrobin.

12. The method according to claim 1 further comprising use of a respiratory chain inhibitor at complex I or II selected from the group consisting of benzovindiflupyr, bixafen, boscalid, carboxin, cyclobutrifluram, flubeneteram, fluindapyr, fluopyram, flutolanil, fluxapyroxad, furametpyr, inpyrfluxam, isofetamid, isoflucypram, isopyrazam, penflufen, penthiopyrad, pydiflumetofen, pyrapropoyne, pyraziflumid, sedaxane, 1,3-dimethyl-N-(1,1,3-trimethyl-2,3-dihydro-1H-inden-4-yl)-1H-pyrazole-4-carboxamide, 1,3-dimethyl-N-[(3R)-1,1,3-trimethyl-2,3-dihydro-1H-inden-4-yl]-1H-pyrazole-4-carboxamide, 1,3-dimethyl-N-[(3S)-1,1,3-trimethyl-2,3-dihydro-1H-inden-4-yl]-1H-pyrazole-4-carboxamide, 1-methyl-3-(trifluoromethyl)-N-[2′-(trifluoromethyl)biphenyl-2-yl]-1H-pyrazole-4-carboxamide, 2-fluoro-6-(trifluoromethyl)-N-(1,1,3-trimethyl-2,3-dihydro-1H-inden-4-yl)benzamide, 3-(difluoromethyl)-1-methyl-N-(1,1,3-trimethyl-2,3-dihydro-1H-inden-4-yl)-1H-pyrazole-4-carboxamide, 3-(difluoromethyl)-1-methyl-N-[(3S)-1,1,3-trimethyl-2,3-dihydro-1H-inden-4-yl]-1H-pyrazole-4-carboxamide, 3-(difluoromethyl)-N-[(3R)-7-fluoro-1,1,3-trimethyl-2,3-dihydro-1H-inden-4-yl]-1-methyl-1H-pyrazole-4-carboxamide, 3-(difluoromethyl)-N-[(3S)-7-fluoro-1,1,3-trimethyl-2,3-dihydro-1H-inden-4-yl]-1-methyl-1H-pyrazole-4-carboxamide, 5,8-difluoro-N-[2-(2-fluoro-4-{[4-(trifluoromethyl)pyridin-2-yl]oxy}phenyl)ethyl]quinazolin-4-amine, N-[(1R,4S)-9-(dichloro-methylene)-1,2,3,4-tetrahydro-1,4-methanonaphthalen-5-yl]-3-(difluoromethyl)-1-methyl-1H-pyrazole-4-carboxamide, N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, N-[1-(2,4-dichlorophenyl)-1-methoxypropan-2-yl]-3-(difluoromethyl)-1-methyl-1H-pyrazole-4-carboxamide and N-[rac-(1S,2S)-2-(2,4-dichlorophenyl)cyclobutyl]-2-(trifluoromethyl)nicotinamide, wherein the respiratory chain inhibitor inhibits a respiratory chain at complex I or II.

13. (canceled)

14. (canceled)

15. (canceled)

16. A method for controlling at least one phytopathogenic fungus in crops, the method comprising use of a dihydroorotate dehydrogenase (DHODH) inhibitor, wherein the at least one phytopathogenic fungus contains a mutation in at least one of an SDH-B gene, an SDH-C gene, and an SDH-D genes, wherein the mutation confers resistance to succinate dehydrogenase inhibitors (SDHI).

17. The method according to claim 16, wherein the DHODH inhibitor is ipflufenoquin.

18. The method according to claim 16, wherein the mutation is selected from the group consisting of B-H272L, B-H272R, B-H272V, B-H272Y, B-H277Y, B-H278R, B-H278Y, B-N225F, B-N225H, B-N225L, B-N225T, B-N230A, B-N230I, B-N230K, B-N230T, C-F23S, C-G79R, C-H152R, C-H134R, C-H134Q, C-I29V, C-K49E, C-L85P, C-N75S, C-N86K, C-N86S, C-P80H, C-P80L, C-P84G, C-R64K, C-R151S, C-S19F, C-S135R, C-T33N, C-T34K, C-T34N, C-T79N, D-D123E, D-D124E, D-D124N, D-D129E, D-D145G, D-G138V, D-H133R and D-H134R.

19. The method according to claim 16, wherein the at least one phytopathogenic fungus is selected from the group consisting of Monographella nivalis, Botrytis cinerea, Pyricularia oryzae, Septoria glycines, Cercospora kikuchii, Cercospora sojina, Rhizoctonia solani, Phakopsora pachyrhizi, Corynespora cassiicola, Blumeria graminis, Sphaerotheca fuliginea, Erysiphe necator, Alternaria solani, Cercospora beticola, Guignardia bidwellii, Magnaporthe grisea, Microdochium nivale, Zymoseptoria tritici, Mycosphaerella fijiensis, Phaeosphaeria nodorum, Pyrenophora teres, Pyrenophora tritici repentis, Ramularia collo-cygni, Ramularia areola, Rhynchosporium secalis, Venturia inaequalis, Monilinia laxa and Sclerotinia sclerotiorum.

20. The method according to claim 19, wherein the at least one phytopathogenic fungus is Zymoseptoria tritici.

21. The method according to claim 16, wherein the crops are selected from the group consisting of wheat, barley, rye, oats, rice, maize, millet/sorghum, sugar beet, fodder beet, apples, pears, quince, peaches, nectarines, cherries, plums, common plums, apricots, strawberries, raspberries, blackberries, blueberries, oranges, lemons, grapefruit, tangerines, beans, lentils, peas, soybeans, oilseed rape, mustard, poppies, olives, sunflowers, coconuts, castor oil plants, cacao, peanuts, pumpkin/squash, cucumbers, melons, cotton, flax, hemp, jute, spinach, lettuce, asparagus, cabbage species, carrots, onions, tomatoes, potatoes, bell peppers, avocado, cinnamomum, camphor, turf, tobacco, nuts, coffee, aubergine, sugar cane, tea, pepper, grapevines, table grapes, hops, bananas, latex plants flowers, shrubs, deciduous trees and coniferous trees.

22. The method according to claim 21, wherein the crops are selected from the group consisting of wheat, barley, rye, oats, rice, maize, sugar beet, apples, pears, quince, peaches, nectarines, cherries, plums, common plums, apricots, strawberries, raspberries, blackberries, blueberries, pumpkin/squash, cucumbers, melons, cotton, spinach, lettuce, cabbage species, carrots, onions, tomatoes, potatoes, bell peppers, nuts, grapevines, table grapes, hops and bananas.

23. The method according to claim 16 further comprising use of a respiratory chain inhibitor selected from the group consisting of ametoctradin, amisulbrom, azoxystrobin, coumethoxystrobin, coumoxystrobin, cyazofamid, dimoxystrobin, enoxastrobin, famoxadone, fenamidone, fenpicoxamid, florylpicoxamid, flufenoxystrobin, fluoxastrobin, kresoxim-methyl, mandestrobin, metarylpicoxamid, metominostrobin, metyltetraprol, orysastrobin, picoxystrobin, pyraclostrobin, pyrametostrobin, pyraoxystrobin, trifloxystrobin, (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (2E,3Z)-5-{[1-(4-chlorophenyl)-1H-pyrazol-3-yl]oxy}-2-(methoxyimino)-N,3-dimethylpent-3-enamide, (2R)-2-{2-[(2,5-dimethylphenoxy)methyl]phenyl}-2-methoxy-N-methylacetamide, (2S)-2-{2-[(2,5-dimethylphenoxy)methyl]phenyl}-2-methoxy-N-methylacetamide, N-(3-ethyl-3,5,5-trimethylcyclohexyl)-3-formamido-2-hydroxybenzamide, (2E,3Z)-5-{[1-(4-chloro-2-fluorophenyl)-1H-pyrazol-3-yl]oxy}-2-(methoxyimino)-N,3-dimethylpent-3-enamide and methyl {5-[3-(2,4-dimethylphenyl)-1H-pyrazol-1-yl]-2-methylbenzyl}carbamate, wherein the respiratory chain inhibitor inhibits a respiratory chain at complex III.

24. The method according to claim 23, wherein the respiratory chain inhibitor is a quinone-outside inhibitor selected from the group consisting of ametoctradin, azoxystrobin, coumethoxystrobin, coumoxystrobin, dimoxystrobin, enoxastrobin, famoxadone, fenamidone, flufenoxystrobin, fluoxastrobin, kresoxim-methyl, mandestrobin, metominostrobin, orysastrobin, picoxystrobin, pyraclostrobin, pyrametostrobin, pyraoxystrobin and trifloxystrobin.

25. The method according to claim 16 further comprising use of a respiratory chain inhibitor selected from the group consisting of benzovindiflupyr, bixafen, boscalid, carboxin, cyclobutrifluram, flubeneteram, fluindapyr, fluopyram, flutolanil, fluxapyroxad, furametpyr, inpyrfluxam, isofetamid, isoflucypram, isopyrazam, penflufen, penthiopyrad, pydiflumetofen, pyrapropoyne, pyraziflumid, sedaxane, 1,3-dimethyl-N-(1,1,3-trimethyl-2,3-dihydro-1H-inden-4-yl)-1H-pyrazole-4-carboxamide, 1,3-dimethyl-N-[(3R)-1,1,3-trimethyl-2,3-dihydro-1H-inden-4-yl]-1H-pyrazole-4-carboxamide, 1,3-dimethyl-N-[(3S)-1,1,3-trimethyl-2,3-dihydro-1H-inden-4-yl]-1H-pyrazole-4-carboxamide, 1-methyl-3-(trifluoromethyl)-N-[2′-(trifluoromethyl)biphenyl-2-yl]-1H-pyrazole-4-carboxamide, 2-fluoro-6-(trifluoromethyl)-N-(1,1,3-trimethyl-2,3-dihydro-1H-inden-4-yl)benz amide, 3-(difluoromethyl)-1-methyl-N-(1,1,3-trimethyl-2,3-dihydro-1H-inden-4-yl)-1H-pyrazole-4-carboxamide, 3-(difluoromethyl)-1-methyl-N-[(3S)-1,1,3-trimethyl-2,3-dihydro-1H-inden-4-yl]-1H-pyrazole-4-carboxamide, 3-(difluoromethyl)-N-[(3R)-7-fluoro-1,1,3-trimethyl-2,3-dihydro-1H-inden-4-yl]-1-methyl-1H-pyrazole-4-carboxamide, 3-(difluoromethyl)-N-[(3S)-7-fluoro-1,1,3-trimethyl-2,3-dihydro-1H-inden-4-yl]-1-methyl-1H-pyrazole-4-carboxamide, 5,8-difluoro-N-[2-(2-fluoro-4-{[4-(trifluoromethyl)pyridin-2-yl]oxy}phenyl)ethyl]quinazolin-4-amine, N-[(1R,4S)-9-(dichloro-methylene)-1,2,3,4-tetrahydro-1,4-methanonaphthalen-5-yl]-3-(difluoromethyl)-1-methyl-1H-pyrazole-4-carboxamide, N-[(1S,4R)-9-(dichloromethylene)-1,2,3,4-tetrahydro-1,4-methanonaphthalen-5-yl]-3-(difluoromethyl)-1-methyl-1H-pyrazole-4-c arb oxamide, N-[1-(2,4-dichlorophenyl)-1-methoxypropan-2-yl]-3-(difluoromethyl)-1-methyl-1H-pyrazole-4-carboxamide and N-[rac-(1S,2S)-2-(2,4-dichlorophenyl)cyclobutyl]-2-(trifluoromethyl)nicotinamide, wherein the respiratory chain inhibitor inhibits a respiratory chain at complex I or II.
